(19) United States
(12) Patent Application Publication
(10) Pub. No.: US 2010/0277620 A1
(43) Pub. Date: Nov. 4, 2010

(54) Imaging Device

(75) Inventors: Yasuhiro IIJIMA, Osaka (JP); Haruo HATANAKA, Kyoto City (JP); Shimpei FUKUMOTO, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/770,199

(22) Filed: Apr. 29, 2010

(30) Foreign Application Priority Data
Apr. 30, 2009 (JP) 2009-110416
Apr. 5, 2010 (JP) 2010-087280

(51) Int. Cl. H04N 5/262; H04N 5/228

(52) U.S. Cl. 348/240.1; 348/222.1; 348/E05.031; 348/E05.055

(57) ABSTRACT

Before performing a zoom in operation, a view angle candidate frame indicating an angle of view after the zoom in operation is superimposed on an input image to generate an output image. A user checks the view angle candidate frame in the output image so as to check in advance an angle of view after the zoom in operation.

This application is based on Japanese Patent Application No. 2009-110416 filed on Apr. 30, 2009 and Japanese Patent Application No. 2010-087280 filed on Apr. 5, 2010, which applications are incorporated herein by reference.

### BACKGROUND OF THE INVENTION

1. Field of the Invention

The present invention relates to an imaging device which controls a zoom state for obtaining a desired angle of view.

2. Description of the Related Art

In recent years, imaging devices for obtaining digital images by imaging are widely available. Some of these imaging devices have a display unit that can display an image before recording a moving image or a still image (on preview) or can display an image when a moving image is recorded. A user can check an angle of view of the image that is being taken by checking the image displayed on the display unit.

For instance, there is proposed an imaging device that can display a plurality of images having different angles of view on the display unit. In particular, there is proposed an imaging device in which an image (moving image or still image) is displayed on the display unit, and a small window is superimposed on the image for displaying another image (still image or moving image).

Here, a user may check the image displayed on the display unit and may want to change the zoom state (e.g., zoom magnification or zoom center position) so as to change an angle of view of the image in many cases. There may be a case where it is difficult to obtain an image of a desired angle of view. The reasons include the following, for example. Because of a time lag among user's operation and a zoom timing or display on the display unit, or other similar factors, zoom in and zoom out operations may be performed a little excessively than a desired state. Another reason is that the object to be imaged may move out of the angle of view when the zoom in operation is performed, with the result that the user may lose sight of the object to be imaged.

In particular, losing sight of the object to be imaged in the zoom in operation can be a problem. When the zoom in operation is performed at high magnification, a displacement in the image due to camera shake or the like increases along with an increase of the zoom magnification. As a result, the object to be imaged is apt to move out of the angle of view during the zoom in operation, so that the user may lose sight of the object easily. In addition, it is also a factor of losing sight of the object that the imaging area is not easily recognized by checking the zoomed-in image at a glance.

Note that, in a case where this problem of losing sight of an object is to be addressed by displaying a plurality of images having different angles of view as the above-mentioned imaging device, the user should check the plurality of images simultaneously and compare the images so as to find the object by assuming the imaging direction and the like. Therefore, even if this method is adopted, it is difficult to find the out-of-sight object.

### SUMMARY OF THE INVENTION

An imaging device of the present invention includes:

an input image generating unit which generates input images sequentially by imaging, which is capable of changing an angle of view of each of the input images; and

a display image processing unit which generates view angle candidate frames indicating angles of view of new input images to be generated when the angle of view is changed, and generating an output image by superimposing the view angle candidate frames on the input image.

### BRIEF DESCRIPTION OF THE DRAWINGS

In the accompanying drawings:

FIG. 1 is a block diagram illustrating a configuration of an imaging device according to an embodiment of the present invention;

FIG. 2 is a block diagram illustrating a configuration of Example 1 of a display image processing unit provided to the imaging device according to the embodiment of the present invention;

FIG. 3 is a flowchart illustrating an operational example of a display image processing unit of Example 1;

FIG. 4 is a diagram illustrating an example of an output image output from the display image processing unit of Example 1;

FIG. 5 is a block diagram illustrating a configuration of Example 2 of the display image processing unit provided to the imaging device according to the embodiment of the present invention;

FIG. 6 is a flowchart illustrating an operational example of a display image processing unit of Example 2;

FIG. 7 is a diagram illustrating an example of an output image output from the display image processing unit of Example 2;

FIG. 8 is a diagram illustrating an example of a zoom operation using both optical zoom and electronic zoom;

FIG. 9 is a diagram illustrating a first example of a generation method for a view angle candidate frame in the display image processing unit of Example 2;

FIG. 10 is a diagram illustrating a second example of the generation method for a view angle candidate frame in the display image processing unit of Example 2;

FIG. 11 is a diagram illustrating a third example of the generation method for a view angle candidate frame in the display image processing unit of Example 2;

FIG. 12 is a diagram illustrating a fourth example of the generation method for a view angle candidate frame in the display image processing unit of Example 2;

FIG. 13 is a diagram illustrating a fifth example of the generation method for a view angle candidate frame in the display image processing unit of Example 2;

FIG. 14 is a diagram illustrating a sixth example of the generation method for a view angle candidate frame in the display image processing unit of Example 2;

FIG. 15 is a diagram illustrating a seventh example of the generation method for a view angle candidate frame in the display image processing unit of Example 2;

FIG. 16 is a diagram illustrating an eighth example of the generation method for a view angle candidate frame in the display image processing unit of Example 2;

FIG. 17 is a diagram illustrating a ninth example of the generation method for a view angle candidate frame in the display image processing unit of Example 2;

FIG. 18 is a diagram illustrating a tenth example of the generation method for a view angle candidate frame in the display image processing unit of Example 2;

FIG. 19 is a block diagram illustrating a configuration of Example 3 of the display image processing unit provided to the imaging device according to the embodiment of the present invention;

FIG. 20 is a flowchart illustrating an operational example of a display image processing unit of Example 3;

FIG. 21 is a diagram illustrating an example of a generation method for a view angle candidate frame in the case of performing a zoom out operation;

FIG. 22 is a diagram illustrating an example of a view angle controlled image clipping process;

FIG. 23 is a diagram illustrating an example of low zoom;

FIG. 24 is a diagram illustrating an example of super resolution processing;

FIG. 25A is a diagram illustrating an example of an output image displaying only four corners of view angle candidate frames;

FIG. 25B is a diagram illustrating an example of an output image displaying only a temporarily determined view angle candidate frame;

FIG. 25C is a diagram illustrating an example of an output image displaying candidate values (zoom magnifications) corresponding to individual view angle candidate frames at a corner of the individual view angle candidate frames; and

FIG. 26 is a diagram illustrating an example of an output image illustrating a display example of a view angle candidate frame.

### DETAILED DESCRIPTION OF PREFERRED EMBODIMENTS

Meanings and effects of the present invention become clearer from the following description of an embodiment. However, the embodiment described below is merely one of embodiments of the present invention. Meanings of the present invention and terms of individual constituent features are not limited to those described in the following embodiment.

Hereinafter, an embodiment of the present invention is described with reference to the accompanying drawings. First, an example of an imaging device of the present invention is described. Note that, the imaging device described below is a digital camera or the like that can record sounds, moving images and still images.

<<Imaging Device>>

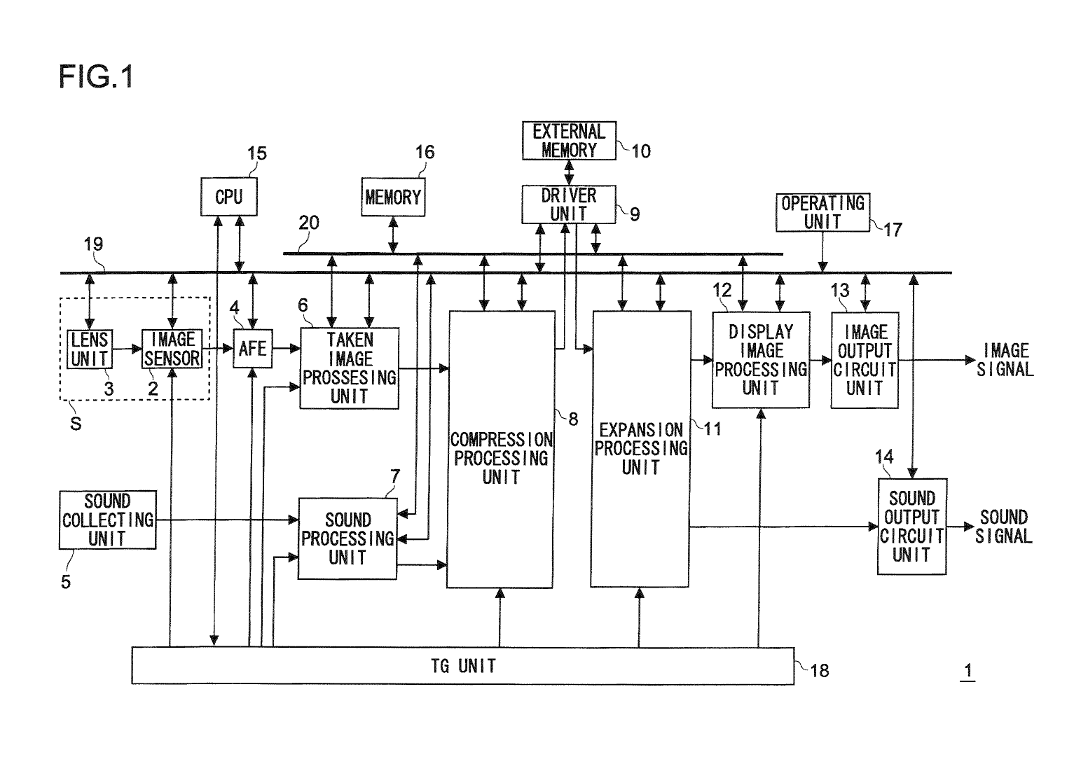

First, a configuration of the imaging device is described with reference to FIG. 1. FIG. 1 is a block diagram illustrating a configuration of an imaging device according to an embodiment of the present invention.

As illustrated in FIG. 1, an imaging device 1 includes an image sensor 2 constituted of a solid-state image sensor such as a charge coupled device (CCD) or a complementary metal oxide semiconductor (CMOS) sensor, which converts an input optical image into an electric signal, and a lens unit 3 which forms the optical image of an object on the image sensor 2 and adjusts light amount and the like. The lens unit 3 and the image sensor 2 constitute an imaging unit S. and an image signal is generated by the imaging unit S. Note that, the lens unit 3 includes various lenses (not shown) such as a zoom lens, a focus lens and the like, an aperture stop (not shown) which adjusts light amount entering the image sensor 2, and the like.

Further, the imaging device 1 includes an analog front end (AFE) 4 which converts the image signal as an analog signal to be output from the image sensor 2 into a digital signal and performs a gain adjustment, a sound collecting unit 5 which converts input sounds into an electric signal, a taken image processing unit 6 which performs an appropriate process on the image signal to be output from the AFE 4, a sound processing unit 7 which converts a sound signal as an analog signal to be output from the sound collecting unit 5 into a digital signal, a compression processing unit 8 which performs a compression coding process fora still image such as Joint Photographic Experts Group (JPEG) compression format on an image signal output from the taken image processing unit 6 and performs a compression coding process for a moving image such as Moving Picture Experts Group (MPEG) compression format on an image signal output from the taken image processing unit 6 and a sound signal from the sound processing unit 7, an external memory 10 which stores a compression coded signal that has been compressed and encoded by the compression processing unit 8, a driver unit 9 which records the image signal in the external memory 10 and reads the image signal from the external memory 10, and an expansion processing unit 11 which expands and decodes the compression coded signal read from the external memory 10 by the driver unit 9.

In addition, the imaging device 1 includes a display image processing unit 12 which performs an appropriate process on the image signal output from the taken image processing unit 6 and on the image signal decoded by the expansion processing unit 11 so as to output the resultant signals, an image output circuit unit 13 which converts the image signal output from the display image processing unit 12 into a signal of a type that can be displayed on a display unit (not shown) such as a monitor, and a sound output circuit unit 14 which converts the sound signal decoded by the expansion processing unit 11 into a signal of a type that can be reproduced by a reproducing unit (not shown) such as a speaker.

In addition, the imaging device 1 includes a central processing unit (CPU) 15 which controls the entire operation of the imaging device 1, a memory 16 which stores programs for performing individual processes and stores temporary signals when the programs are executed, an operating unit 17 for entering instructions from the user which includes a button for starting imaging and a button for determining various settings, a timing generator (TG) unit 18 which outputs a timing control signal for synchronizing operation timings of individual units, a bus line 19 for communicating signals between the CPU 15 and the individual units, and a bus line 20 for communicating signals between the memory 16 and the individual units.

Note that, any type of the external memory 10 can be used as long as the external memory 10 can record image signals and sound signals. For instance, a semiconductor memory such as a secure digital (SD) card, an optical disc such as a DVD, or a magnetic disk such as a hard disk can be used as the external memory 10. In addition, the external memory 10 may be detachable from the imaging device 1.

In addition, it is preferred that the display unit and the reproducing unit be integrated with the imaging device 1, but the display unit and the reproducing unit may be separated from the imaging device 1 and may be connected with the imaging device 1 using terminals thereof and a cable or the like.

Next, a basic operation of the imaging device 1 is described with reference to FIG. 1. First, the imaging device 1 performs photoelectric conversion of light entering from the lens unit 3 by the image sensor 2 so as to obtain an image signal as an electric signal. Then, the image sensor 2 outputs the image signals sequentially to the AFE 4 at a predetermined frame period (e.g., every 1/30 seconds) in synchronization with the timing control signal supplied from the TG unit 18.

The image signal converted from an analog signal into a digital signal by the AFE 4 is supplied to the taken image processing unit 6. The taken image processing unit 6 performs processes on the input image signal, which include an electronic zoom process in which a certain image portion is clipped from the supplied image signal and interpolation (e.g., bilinear interpolation) and the like are performed so that an image signal of an enlarged image is obtained, a conversion process into a signal using a luminance signal (Y) and color difference signals (U, V), and various adjustment processes such as gradation correction and edge enhancement. In addition, the memory 16 works as a frame memory so as to hold the image signal temporarily when the taken image processing unit 6, the display image processing unit 12, and the like perform processes.

The CPU 15 controls the lens unit 3 based on a user's instruction or the like input via the operating unit 17. For instance, positions of various types of lenses of the lens unit 3 and the aperture stop are adjusted so that focus and exposure can be adjusted. Note that, those adjustments may be performed automatically by a predetermined program based on the image signal processed by the taken image processing unit 6.

Further in the same manner, the CPU 15 controls the zoom state based on a user's instruction or the like. Specifically, the CPU 15 drives the zoom lens of the lens unit 3 so as to control the optical zoom and controls the taken image processing unit 6 so as to control the electronic zoom. Thus, the zoom state becomes a desired state.

In the case of recording a moving image, not only an image signal but also a sound signal is recorded. The sound signal, which is converted into an electric signal and is output by the sound collecting unit 5, is supplied to the sound processing unit 7 to be converted into a digital signal, and a process such as noise reduction is performed on the signal. Then, the image signal output from the taken image processing unit 6 and the sound signal output from the sound processing unit 7 are both supplied to the compression processing unit 8 and are compressed into a predetermined compression format by the compression processing unit 8. In this case, the image signal and the sound signal are associated with each other in a temporal manner so that the image and the sound are not out of synchronization when reproduced. Then, the compressed image signal and sound signal are recorded in the external memory 10 via the driver unit 9.

On the other hand, in the case of recording only a still image or sound, the image signal or the sound signal is compressed by a predetermined compression method in the compression processing unit 8 and is recorded in the external memory 10. Note that, different processes may be performed in the taken image processing unit 6 between the case of recording a moving image and the case of recording a still image.

The image signal and the sound signal after being compressed and recorded in the external memory 10 are read by the expansion processing unit 11 based on a user's instruction. The expansion processing unit 11 expands the compressed image signal and sound signal. Then, the image signal is output to the image output circuit unit 13 via the display image processing unit 12, and the sound signal is output to the sound output circuit unit 14. The image output circuit unit 13 and the sound output circuit unit 14 convert the image signal and the sound signal into signals of types that can be displayed and reproduced by the display unit and the reproducing unit and output the signals, respectively. The image signal output from the image output circuit unit 13 is displayed on the display unit or the like and the sound signal output from the sound output circuit unit 14 is reproduced by the reproducing unit or the like.

Further in the same manner, in the preview operation before recording a moving image or a still image, or in recording of a moving image, the image signal output from the taken image processing unit 6 is supplied also to the display image processing unit 12 via the bus line 20. Then, after the display image process unit 12 performs an appropriate image processing for display, the signal is supplied to the image output circuit unit 13 and is converted into a signal of a type that can be displayed on the display unit and is output.

The user checks the image displayed on the display unit so as to confirm the angle of view of the image signal that is to be recorded or is being recorded. Therefore, it is preferred that the angle of view of the image signal for recording supplied from the taken image processing unit 6 to the compression processing unit 8 be substantially the same as the angle of view of the image signal for display supplied to the display image processing unit 12, and those image signals may be the same image signal. Note that, details of the configuration and the operation of the display image processing unit 12 are described as follows.

<<Display Image Processing Unit>>

The display image processing unit 12 illustrated in FIG. 1 is described with reference to examples and the accompanying drawings. Note that, in the following description of the examples, the image signal supplied to the display image processing unit 12 is expressed as an image and is referred to as an “input image” for concrete description. In addition, the image signal output from the display image processing unit 12 is expressed as an “output image”. Note that, the image signal for recording supplied from the taken image processing unit 6 to the compression processing unit 8 is also expressed as an image and is regarded to have substantially the same angle of view as that of the input image. Further, in the present invention, the angle of view is an issue in particular. Therefore, the image having substantially the same angle of view as that of the input image is also referred to as an input image so that description thereof is simplified.

In addition, in the following individual examples, the case where the user issues the instruction to the imaging device 1 to perform zoom in operation is described. The case of issuing the instruction to perform zoom out operation is described separately after description of the individual examples. In the same manner, in each example, the case of performing in the imaging operation (in the preview operation or in the moving image recording operation) is described. The case of performing in the reproducing operation is described separately after description of each example. Note that, description of each example can be applied to other examples unless a contradiction arises.

### Example 1

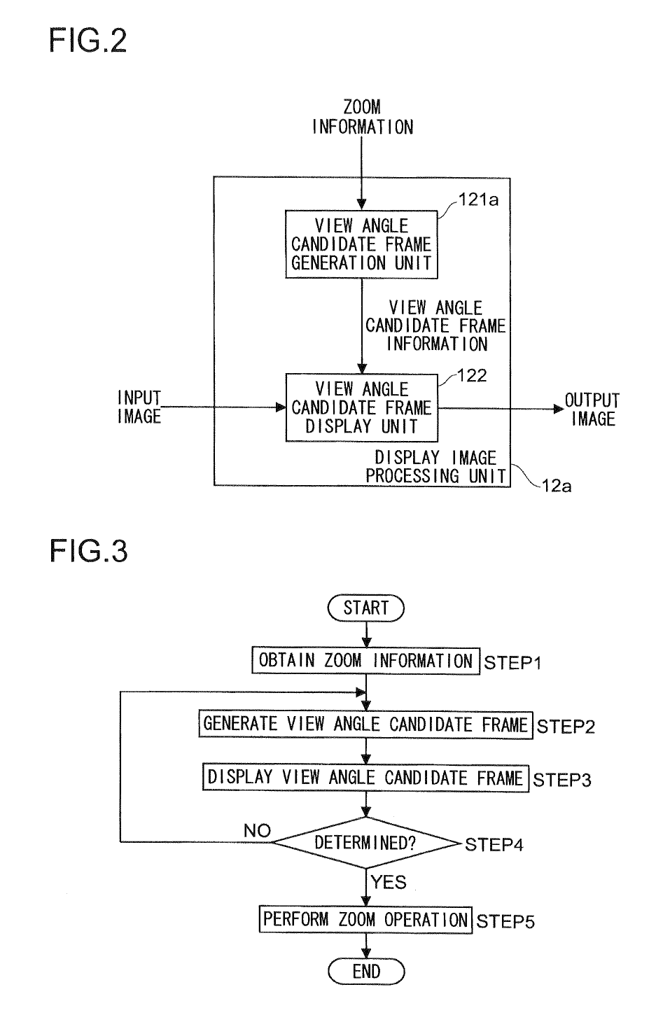

First, Example 1 of the display image processing unit 12 is described. FIG. 2 is a block diagram illustrating a configuration of Example 1 of the display image processing unit provided to the imaging device according to the embodiment of the present invention.

As illustrated in FIG. 2, a display image processing unit 12a of this example includes a view angle candidate frame generation unit 121a which generates view angle candidate frames based on zoom information and outputs the view angle candidate frames as view angle candidate frame information, and a view angle candidate frame display unit 122 which superimposes the view angle candidate frames indicated by the view angle candidate frame information on the input image so as to generate an output image to be output.

The zoom information includes, for example, information indicating a zoom magnification of the current setting (zoom magnification when the input image is generated) and information indicating limit values (upper limit value and lower limit value) of the zoom magnification to be set. Note that, unique values of the limit values of the zoom magnification and the like may be recorded in advance in the view angle candidate frame generation unit 121a.

The view angle candidate frame indicates virtually the angle of view of the input image to be obtained if the currently set zoom magnification is changed to a different value (candidate value), by using the current input image. In other words, the view angle candidate frame expresses a change in angle of view due to a change in zoom magnification, in a visual manner.

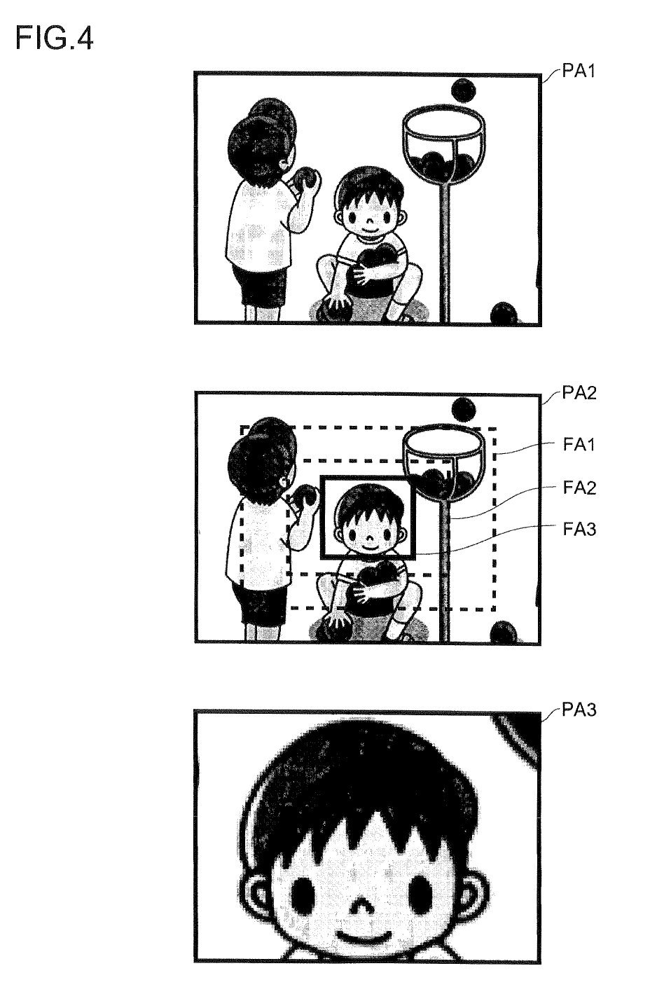

In addition, an operation of the display image processing unit 12a of this example is described with reference to FIG. 3 and FIG. 4, FIG. 3 is a flowchart illustrating an operational example of the display image processing unit 12a of Example 1. FIG. 4 is a diagram illustrating an example of the output image output from the display image processing unit 12a of Example 1.

As described above, in the preview operation before recording an image or in recording of a moving image, the input image output from the taken image processing unit 6 is supplied to the display image processing unit 12a via the bus line 20. In this case, if an instruction for the zoom in operation is not supplied to the imaging device 1 from the user via the operating unit 17, the display image processing unit 12a outputs the input image as it is to be an output image, for example, an output image PA1 illustrated in the upper part of FIG. 4.

On the other hand, if an instruction from the user to perform the zoom in operation is supplied to the imaging device 1, the display image processing unit 12a performs the display operation of view angle candidate frames illustrated in FIG. 3. When the display operation of the view angle candidate frames is started, the view angle candidate frame generation unit 121a first obtains the zoom information (STEP 1). Thus, the view angle candidate frame generation unit 121a recognizes the currently set zoom magnification. In addition, the view angle candidate frame generation unit 121a also recognizes the upper limit value of the zoom magnification.

Next, the view angle candidate frame generation unit 121a generates the view angle candidate frames (STEP 2). In this case, candidate values of the changed zoom magnification are set. As a method of setting the candidate values of the zoom magnification, for example, values obtained by dividing equally between the currently set zoom magnification and the upper limit value of the zoom magnification, and the upper limit value may be set as the candidate values. Specifically, for example, when it is supposed that the currently set zoom magnification is ×1, the upper limit value is ×12, and values obtained by dividing equally into three are set as candidate values, ×12, ×8, and ×4 are set as the candidate values.

The view angle candidate frame generation unit 121a generates the view angle candidate frames corresponding to the set candidate values. The view angle candidate frame display unit 122 superimposes the view angle candidate frames generated by the view angle candidate frame generation unit 121a on the input image so as to generate the output image. An example of the output image generated in this way is illustrated in the middle part of FIG. 4. An output image PA2 illustrated in the middle part of FIG. 4 is obtained by superimposing a view angle candidate frame FA1 corresponding to the candidate value of ×4, a view angle candidate frame FA2 corresponding to the candidate value of ×8, and a view angle candidate frame FA3 corresponding to the candidate value (upper limit value) of ×12 on the input image under the current zoom magnification of ×1.

In this example, it is supposed that the center of the input image is not changed before and after the zoom operation as in the case of optical zoom. Therefore, based on the current zoom magnification and the candidate values, positions and sizes of the view angle candidate frames FA1 to FA3 can be set. Specifically, the centers of the view angle candidate frames FA1 to FA3 are set to match the center of the input image, and the size of the view angle candidate frame is set to decrease in accordance with an increase of the candidate value with respect to the current zoom magnification

The output image generated and output as described above is supplied from the display image processing unit 12a via the image output circuit unit 13 to the display unit and is displayed (STEP 3). The user checks the displayed output image and determines one of the view angle candidate frames (STEP 4).

For instance, in the case where the operating unit 17 has a configuration including a zoom key (or cursor key) and an enter button, the user operates the zoom key so as to change a temporarily determined view angle candidate frame in turn, and presses the enter button so as to determine the temporarily determined view angle candidate frame. When the decision is performed in this way, it is preferred that the view angle candidate frame generation unit 121a display the view angle candidate frame FA3 that is temporarily determined by the zoom key in a different shape from others as illustrated in the middle part of FIG. 4 as the output image PA2, so that the temporarily determined view angle candidate frame FA3 may be discriminated. For instance, the temporarily determined view angle candidate frame may be emphasized by displaying the entire perimeter of the angle of view indicated by the relevant view angle candidate frame with a thick line or a solid line while other view angle candidate frames that are not being temporarily determined may not be emphasized by displaying the entire perimeter of the angle of view indicated by the relevant view angle candidate frame with a thin line or a broken line. Note that, in the case where the operating unit 17 is constituted of a touch panel or other unit that can specify any position, the view angle candidate frame that is closest to the position specified by the user may be determined or temporarily determined.

If the user does not determine one of the view angle candidate frames (NO in STEP 4), the process flow goes back to STEP 2 so as to generate view angle candidate frames. Then, the view angle candidate frames are displayed in STEP 3. In other words, generation and display of the view angle candidate frames are continued until the user determines the view angle candidate frame.

On the other hand, if the user determines one of the view angle candidate frames (YES in STEP 4), the zoom in operation is performed so that the image having the angle of view of the determined view angle candidate frame is obtained (STEP 5), and the operation is finished. In other words, the zoom magnification is changed to the candidate value corresponding to the determined view angle candidate frame, and the operation is finished. If the view angle candidate frame FA3 is determined in the output image PA2 illustrated in the middle part of FIG. 4, for example, an output image PA3 illustrated in the lower part of FIG. 4 having substantially the same angle of view as the view angle candidate frame FA3 is obtained by the zoom in operation.

With the configuration described above, the user can confirm the angle of view after the zoom in operation before performing the zoom in operation. Therefore, it is possible to obtain an image having a desired angle of view easily, so that zoom operability can be improved. In addition, it is possible to reduce the possibility of losing sight of the object during the zoom in operation.

Note that, as the zoom operation performed in this example, it is possible to use the optical zoom or the electronic zoom, or to use both of them concurrently. The optical zoom changes the optical image itself on the imaging unit S, and is more preferred than the electronic zoom in which the zoom is realized by image processing, because deterioration of image quality is less in the optical zoom. However, even if the electronic zoom is used, if it is a special electronic zoom such as a super resolution processing or low zoom (details of which are described later), it can be used appropriately because it has little deterioration in image quality.

If this example is applied to the imaging device 1 that uses the optical zoom, the zoom operation becomes easy so that a failure (e.g., repetition of the zoom in and zoom out operations due to excessive operation of the zoom) can be suppressed. Thus, driving quantity of the zoom lens or the like can be reduced. Therefore, power consumption can be reduced.

In addition, it is possible to set the candidate values set in STEP 2 to be shifted to the high magnification side. For instance, if the current zoom magnification is ×1l and the upper limit value is ×12, it is possible to set the candidate values to ×8, ×10, and ×12. On the contrary, it is possible to set the candidate values to be shifted to the low magnification side. For instance, if the current zoom magnification is ×1, and the upper limit value is ×12, it is possible to set the candidate values to ×2, ×4, and ×6. In addition, the setting method for the candidate value may be set in advance by the user. In addition, instead of using the upper limit value or the current zoom magnification as the reference, it is possible to set a candidate value to be a reference on the high magnification side or the low magnification side and set values in increasing or decreasing order from the candidate value as other candidate values.

In addition, it is possible to increase the number of view angle candidate frames to be generated if a difference between the current zoom magnification and the upper limit value is large and to decrease the number of view angle candidate frames to be generated if the difference is small. With this configuration, it is possible to reduce the possibility that a view angle candidate frame of a size that the user want to determine is not displayed because the number of view angle candidate frames to be displayed is small. In addition, it is possible to reduce the possibility that displayed view angle candidate frames are crowded so that the background input image is hard to see or it is difficult for the user to determine one of the view angle candidate frames.

In addition, the user may not only determine one of the view angle candidate frames FA1 to FA3 in STEP 4 but also perform fine adjustment of the size (candidate value) of the determined one of the view angle candidate frames FA1 to FA3. For instance, it is possible to adopt a configuration in which any of the view angle candidate frames FA1 to FA3 is primarily determined in the output image PA2 illustrated in the middle part of FIG. 4, and then a secondary decision (fine adjustment) is performed using a zoom key or the like for enlarging or reducing (increasing or decreasing the candidate value of) the primarily determined view angle candidate frame. In addition, it is preferred that the view angle candidate frame generation unit 121a do not generate the view angle candidate frames that are not primarily determined when the secondary decision is performed so that the user can perform the fine adjustment easily. In addition, as a configuration of generating only one view angle candidate frame from the beginning, it is possible to perform only the above-mentioned secondary decision. In addition, it is possible to use different shapes for displaying the primarily determined view angle candidate frame (temporarily determined and non-temporarily determined) and the secondarily determined view angle candidate frame.

In addition, when the zoom in operation is performed in STEP 5, it is possible to zoom in gradually or zoom in as fast as possible (the highest speed is the driving speed of the zoom lens). In addition, when this example is performed in the recording operation of a moving image, it is possible not to record the input image during the zoom operation (while the zoom magnification is changing)

### Example 2

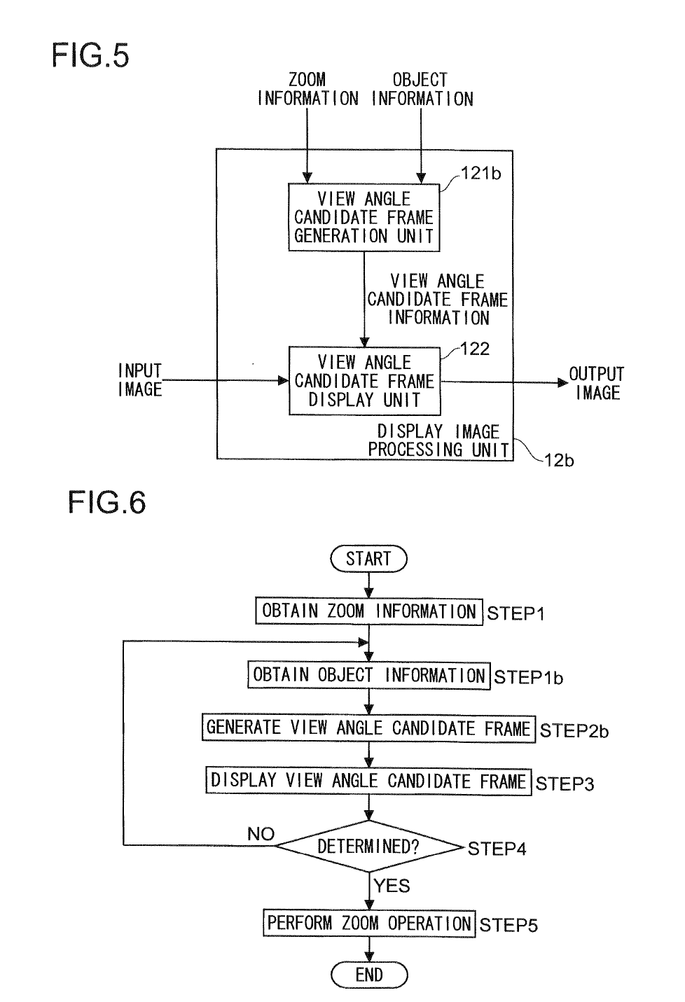

Example 2 of the display image processing unit 12 is described. FIG. 5 is a block diagram illustrating a configuration of Example 2 of the display image processing unit provided to the imaging device according to the embodiment of the present invention, which corresponds to FIG. 2 illustrating Example 1. Note that, in FIG. 5, parts similar to those in FIG. 2 illustrating Example 1 are denoted by similar names and symbols so that detailed descriptions thereof are omitted.

As illustrated in FIG. 5, a display image processing unit 12b of this example includes a view angle candidate frame generation unit 121b which generates the view angle candidate frames based on the zoom information and the object information, and outputs the same as view angle candidate frame information, and a view angle candidate frame display unit 122. This example is different from Example 1 in that the view angle candidate frame generation unit 121b generates the view angle candidate frames based on not only the zoom information but also the object information.

The object information includes, for example, information about a position and a size of a human face in the input image detected from the input image, and information about a position and a size of a human face that is recognized to be a specific face in the input image. Note that, the object information is not limited to information about the human face, and may include information about a position and a size of a specific color part or a specific object (e.g., an animal), which is designated by the user via the operating unit 17 (a touch panel or the like) in the input image in which the designated object or the like is detected.

The object information is generated when the taken image processing unit 6 or the display image processing unit 12b detects (tracks) the object sequentially from the input images that are created sequentially. The taken image processing unit 6 may detect the object for performing the above-mentioned adjustment of focus and exposure. Therefore, it is preferred to adopt a configuration in which the taken image processing unit 6 generates the object information, so that a result of the detection may be employed. It is also preferred to adopt a configuration in which the display image processing unit 12b generates the object information, so that the display image processing unit 12b of this example can operate in not only the imaging operation but also the reproduction operation.

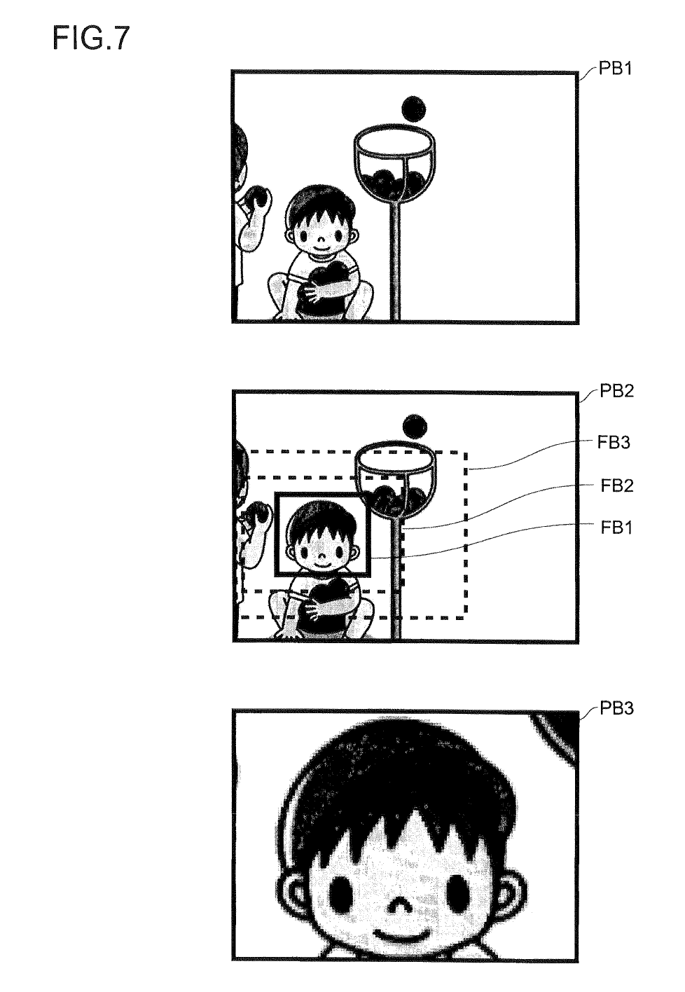

In addition, an operation of the display image processing unit 12b of this example is described with reference to the drawings. FIG. 6 is a flowchart illustrating an operational example of the display image processing unit of Example 2, which corresponds to FIG. 3 illustrating Example 1. In addition, FIG. 7 is a diagram illustrating an output image output from the display image processing unit of Example 2, which corresponds to FIG. 4 illustrating Example 1. Note that, in FIGS. 6 and 7 illustrating Example 2, parts similar to those in FIGS. 3 and 4 illustrating Example 1 are denoted by similar names and symbols so that detailed descriptions thereof are omitted.

Similarly to Example 1, in the preview operation before recording an image or in recording operation of a moving image, the input image output from the taken image processing unit 6 is supplied to the display image processing unit 12b via the bus 20. In this case, if an instruction of the zoom in operation is not supplied to the imaging device 1 from the user via the operating unit 17, the display image processing unit 12b outputs the input image as it is to be an output image, for example, an output image PB1 illustrated in the upper part of FIG. 7.

On the other hand, if an instruction from the user to perform the zoom in operation is input to the imaging device 1, the display image processing unit 12b performs the display operation of the view angle candidate frames illustrated in FIG. 6. When the display operation of the view angle candidate frames is started, the view angle candidate frame generation unit 121b first obtains the zoom information (STEP 1). Further, in this example, the view angle candidate frame generation unit 121b also obtains the object information (STEP 1b). Thus, the view angle candidate frame generation unit 121b recognizes not only the currently set zoom magnification and the upper limit value but also a position and a size of the object in the input image.

In this example, the view angle candidate frame generation unit 121b generates the view angle candidate frames so as to include the object in the input image (STEP 2b). Specifically, if the object is a human face, the view angle candidate frames are generated as a region including the face, a region including the face and the body, and a region including the face and the peripheral region. In this case, it is possible to determine the zoom magnifications corresponding to the individual view angle candidate frames from sizes of the view angle candidate frames and the current zoom magnification. In addition, for example, similarly to Example 1, it is possible to set the candidate values so as to set sizes of the individual view angle candidate frames, and to generate each of the view angle candidate frames at a position including the object

Similarly to Example 1, the view angle candidate frame display unit 122 superimposes the view angle candidate frames generated by the view angle candidate frame generation unit 121b on the input image so as to generate the output image. An example of the generated output image is illustrated in the middle part of FIG. 7. The output image PB2 illustrated in the middle part of FIG. 7 shows, as the example described above, a view angle candidate frame FB1 of the region including the face (the zoom magnification is ×12), a view angle candidate frame FB2 of the region including the face and the body (the zoom magnification is ×8), and a view angle candidate frame FB3 of the region including the face and the peripheral region (the zoom magnification is ×6).

It is preferred that the centers of the view angle candidate frames FB1 to FB3 agree with the center of the object, so that the object after the zoom in operation is positioned at the center of the input image. However, if the angle of view outside the output image is included when the center of any of the view angle candidate frames matches the center of the object, the view angle candidate frame should be generated at a position shifted so as to be within the output image PB2 as in the case of the view angle candidate frame FB3 in the output image PB2 illustrated in the middle part of FIG. 7. Alternatively, it is possible to generate the view angle candidate frame of a size that does not include the outside of the output image PB2 (e.g., to change the zoom magnification from ×6 to ×7).

The output image generated as described above is displayed on the display unit (STEP 3), and the user checks the displayed output image to determine one of the view angle candidate frames (STEP 4). Here, if the user does not determine one of the view angle candidate frames (NO in STEP 4), generation and display of the view angle candidate frames are continued. In this example, the view angle candidate frame is generated based on a position of the object in the input image. Therefore, the process flow goes back to STEP 1b so as to obtain the object information.

On the other hand, if the user determines one of the view angle candidate frames (YES in STEP 4), and the zoom in operation is performed so that the image having the angle of view of the determined view angle candidate frame is obtained (STEP 5) to end the operation. If the view angle candidate frame FB1 is determined in the output image PB2 illustrated in the middle part of FIG. 7, for example, the output image PB3 illustrated in the lower part of FIG. 7 having substantially the same angle of view as the view angle candidate frame FB1 is obtained by the zoom in operation.

In this example, positions of the view angle candidate frames FB1 to FB3 (i.e., the center of zoom) are determined in accordance with a position of the object. Therefore, there may be a case where the centers of the input images before and after the zoom in operation are not the same. Therefore, it is assumed in STEP 5 to perform the electronic zoom or the like that can perform such a zoom.

With the configuration described above, similarly to Example 1, the user can confirm the angle of view after the zoom in operation before performing the zoom in operation. Therefore, it is possible to obtain an image having a desired angle of view easily, so that zoom operability can be improved. In addition, it is possible to reduce the possibility of losing sight of the object during the zoom in operation.

Further, in this example, the view angle candidate frames FB1 to FB3 include the object. Therefore, it is possible to reduce the possibility that the input image after the zoom in operation does not include the object by performing the zoom in operation so as to obtain the image of one of the angles of view.

Note that, as the zoom operation performed in this example, it is possible to use the optical zoom as well as the electronic zoom, or it is possible to use both of them. In the case of using the optical zoom, it is preferred to provide a mechanism of shifting the center of the input image between before and after the zoom (e.g., a shake correction mechanism that can drive the lens in directions other than the directions along the optical axis).

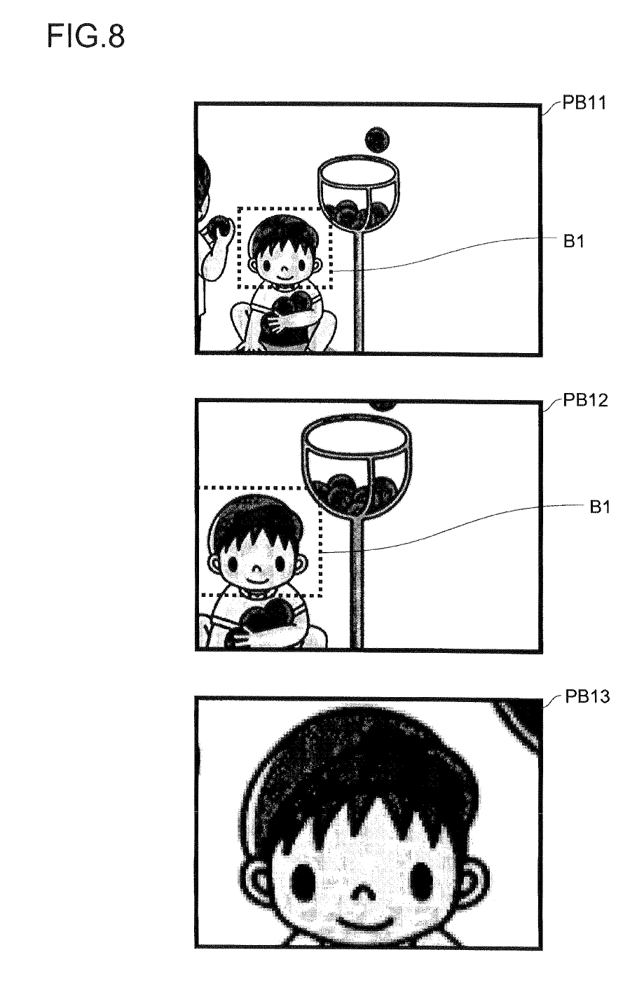

In addition, a zoom operation using both the optical zoom and the electronic zoom are described with reference to FIG. 8. FIG. 8 is a diagram illustrating an example of a zoom operation using both the optical zoom and the electronic zoom. In addition, FIG. 8 illustrates the case where the input image having an angle of view B1 is to be obtained by the zoom in operation,

In this example, the zoom in operation is performed first using the optical zoom. When the zoom in operation is performed by the optical zoom in the input image PB11 illustrated in the upper part of FIG. 8, the zoom in operation is performed while maintaining the position of the center. Then, a size of the angle of view B1 in the input image increases, so that an end side of the angle of view E1 (the left side in this example) overlaps the end side (the left side in this example) of the input image PB12, as in the input image PB12 illustrated in the middle part of FIG. 8. Then, if the zoom in operation is performed further from this state by the optical zoom, a part of the angle of view B1 becomes outside the input image. Therefore, the further zoom in operation is performed by using the electronic zoom. Thus, it is possible to obtain an input image PB13 of the angle of view B1 illustrated in the lower part of FIG. 8.

If both the optical zoom and the electronic zoom are used in this way, it is possible to suppress deterioration in image quality due to the electronic zoom (simple electronic zoom without a special super resolution processing or low zoom). In addition, because both types of zoom can be used, the range of zoom that can be performed can be enlarged. In particular, if the angle of view desired by the user cannot be obtained only by the electronic zoom, combined use of the optical zoom enables to generate the image with the angle of view desired by the user.

The example illustrated in FIG. 8 suppress deterioration in image quality by making the maximum use of the optical zoom, but the effect of the suppressing deterioration in image quality can be obtained by using the optical zoom in any way. In addition, it is possible to shorten the processing time and to reduce power consumption by using a simple electronic zoom.

In addition, similarly to Example 1, if this example is applied to the imaging device 1 that uses the optical zoom, the zoom operation becomes easy so that a failure can be suppressed. Thus, driving quantity of the zoom lens or the like can be reduced, to thereby reduce power consumption.

In addition, as described above in Example 1, it is possible to adopt a configuration in which, when one of the view angle candidate frames FB1 to FB3 is determined in STEP 4, the user can perform fine adjustment of the view angle candidate frame. In addition, when the zoom operation is performed in STEP 5, it is possible to zoom gradually or zoom as fast as possible. In addition, in the recording operation of a moving image, it is possible not to record the input image during the zoom operation.

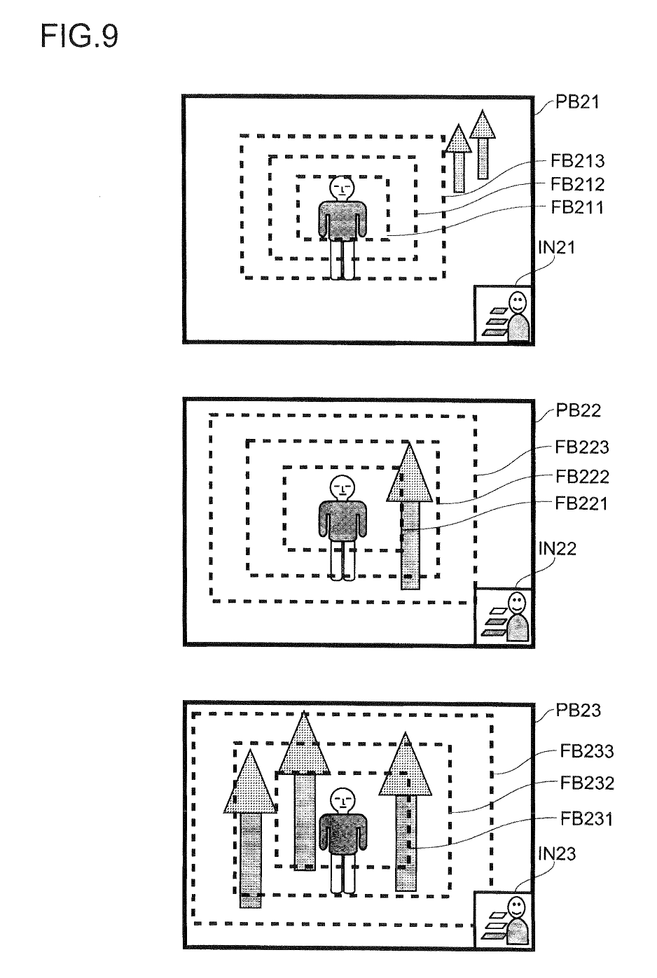

Hereinafter, specific examples of the generation method for the view angle candidate frames in this example are described with reference to the drawings. FIGS. 9 to 18 are diagrams illustrating respectively first to tenth examples of the generation method for the view angle candidate frames in the display image processing unit of Example 2. Note that, the first to the tenth examples described below may be used in combination.

### First Example

In a first example, the view angle candidate frames are generated by utilizing detection accuracy of the object (tracking reliability). First, an example of a method of calculating tracking reliability is described. Note that, as a method of detecting an object, the case where the detection is performed based on color information of the object (RGB or H of hue (H), saturation (S), and brightness (V)) is used are described as a specific example.

In the method of calculating the tracking reliability in this example, the input image is first divided into a plurality of small blocks, and the small blocks (object blocks) to which the object belongs and other small blocks (background blocks) are classified. For instance, it is considered that the background exists at a point sufficiently distant from the center point of the object. The classification is performed based on determination whether the pixels at individual positions between the points indicate the object or the background from image characteristics (information of luminance and color) of both points. Then, a color difference score indicating a difference between color information of the object and color information of the image in the background blocks is calculated for each background block. It is supposed that there are Q background blocks, and color difference scores calculated for the first to the Q-th background blocks are denoted by C_{DIS} [1] to C_{DIS} [Q] respectively. The color difference score C_{DIS} [i] is calculated by using a distance between a position on the (RGB) color space obtained by averaging color information (e.g., RGB) of pixels that belong to the i-th background block and a position on the color space of color information of the object. It is supposed that the color difference score C_{DIS} [i] can take a value within the range of 0 or more to 1 or less, and the color space is normalized. Further, position difference scores P_{DIS} [1] to P_{DIS} [Q] each indicating a spatial position difference between the center of the object and the background block are calculated for individual background blocks. For instance, the position difference score P_{DIS} [i] is calculated by using a distance between the center of the object and a vertex closest to the center of the object among four vertexes of the i-th background block. It is supposed that the position difference score P_{DIS} [i] can take a value within the range of 0 or more to 1 or less, and that the space region of the image to be calculated is normalized.

Based on the color difference score and the position difference score determined as described above, the integrated distance CP_{DIS} is calculated from Expression (1) below. Then, using the integrated distance CP_{DIS}, the tracking reliability score EV_{R} is calculated from Expression (2) below. In other words, if “CP_{DIS}>100” is satisfied, the tracking reliability score is set to “EV_{R}=0”. If “CP_{DIS}≦100” is satisfied, the tracking reliability score is set to “EV_{R}=100−CP_{DIS}”. Further, in this calculation method, if a background having the same color or similar color to the color of a main subject exists close to the main subject, the tracking reliability score EV_{R} becomes low. In other words, the tracking reliability becomes small.

$$\begin{matrix}{CP}_{DIS} = {\sum }_{i = 1}^{Q} \sqrt{( 1 - {C}_{DIS} ( i ) ) \times ( 1 - {P}_{DIS} ( i ) )} & ( 1 ) \\ {EV}_{R} = \{ \begin{matrix}0 \text{:} & {CP}_{DIS} > 100 \\ 100 - {CP}_{DIS} \text{:} & {CP}_{DIS} \leq 100\end{matrix} & ( 2 )\end{matrix}$$

In this example, as illustrated in FIG. 9, sizes of the view angle candidate frames to be generated are determined based on the tracking reliability. Specifically, it is supposed that as the tracking reliability becomes smaller (the value indicated by an indicator becomes smaller), the view angle candidate frame to be generated is set larger. In the example illustrated in FIG. 9, values of indicators IN21 to IN23 decrease in the order of an output image PB21 illustrated in the upper part of FIG. 9, an output image PB22 illustrated in the middle part of FIG. 9, and an output image PB23 illustrated in the lower part of FIG. 9. Therefore, sizes of the view angle candidate frames increase in the order of FB211 to FB213 of the output image PB21 illustrated in the upper part of FIG. 9, FB221 to FB223 of the output image PB22 illustrated in the middle part of FIG. 9, and FP231 to FB233 of the output image PB23 illustrated in the lower part of FIG. 9.

With this configuration, the generated view angle candidate frames become larger as the tracking reliability is smaller. Therefore, even if the tracking reliability is decreased, it is possible to increase the probability that the object is included in the generated view angle candidate frames.

Note that, the indicators IN21 to IN23 are displayed on the output image PB21 to PB23 for convenience of description in FIG. 9, but it is possible to adopt a configuration in which the indicators IN21 to IN23 are not displayed.

### Second Example

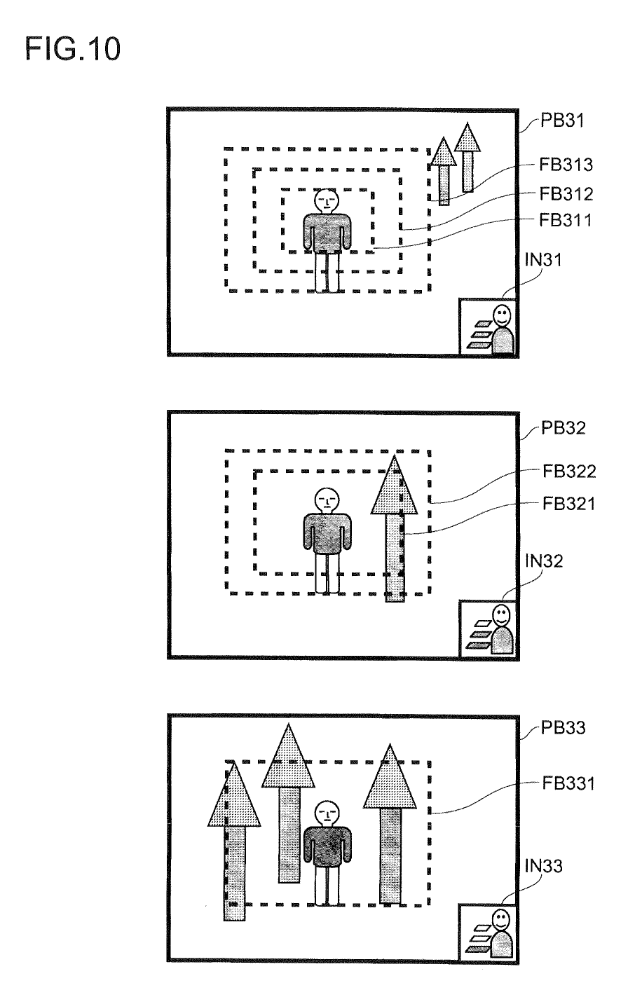

In a second example also, the tracking reliability is used similarly to the first example. In particular, as illustrated in FIG. 10, the number of the view angle candidate frames to be generated is determined based on the tracking reliability. Specifically, as the tracking reliability becomes smaller, the number of the view angle candidate frames to be generated is set smaller. In the example illustrated in FIG. 10, values of indicators IN31 to IN33 descend in the order of an output image PB31 illustrated in the upper part of FIG. 10, an output image PB32 illustrated in the middle part of FIG. 10, and an output image PB33 illustrated in the lower part of FIG. 10. Therefore, the number of the view angle candidate frames to be generated is decreased in the order of FB311 to FB313 (three) of the output image PB31 illustrated in the upper part of FIG. 10, FB321 and FB322 (two) of the output image PB32 illustrated in the middle part of FIG. 10, and FB 331 (one) of the output image PB33 illustrated in the lower part of FIG. 10.

With this configuration, as the tracking reliability becomes lower, the number of the view angle candidate frames to be generated is decreased. Therefore, if the tracking reliability is small, it may become easier for the user to determine one of the view angle candidate frames.

Note that, the method of calculating the tracking reliability may be the method described above in the first example. In addition, similarly to the first example, it is possible to adopt a configuration in which the indicators IN31 to IN33 are not displayed in the output images PB31 to PB33 illustrated in FIG. 10.

### Third Example

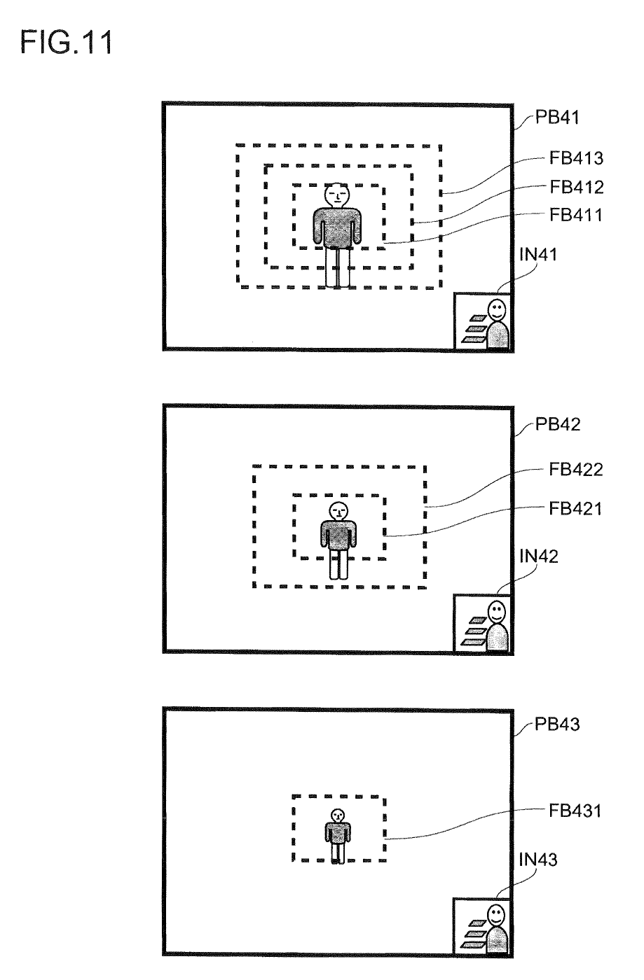

In a third example, as illustrated in FIG. 11, the number of the view angle candidate frames to be generated is determined based on the size of the object. Specifically, as the size of the object becomes smaller, the number of the view angle candidate frames to be generated is set smaller. In the example illustrated in FIG. 11, the size of the object descends in the order of an output image PB41 illustrated in the upper part of FIG. 11, an output image PB42 illustrated in the middle part of FIG. 11, and an output image PB43 illustrated in the lower part of FIG. 11. Therefore, the number of the view angle candidate frames to be generated is decreased in the order of FB411 to FF413 (three) of the output image PB41 illustrated in the upper part of FIG. 11, FB421 and FB422 (two) of the output image PB42 illustrated in the middle part of FIG. 11, and FB 431 (one) of the output image PB43 illustrated in the lower part of FIG. 11.

With this configuration, as the size of the object becomes lower, the number of the view angle candidate frames to be generated is decreased. Therefore, if the size of the object is small, it may become easier for the user to determine one of the view angle candidate frames. In particular, if this example is applied to the case of generating the view angle candidate frames having sizes corresponding to a size of the object, it is possible to reduce the possibility that the view angle candidate frames are crowded close to the object when the object becomes small so that it becomes difficult for the user to determine one of the view angle candidate frames.

Note that, indicators 1N41 to IN43 are displayed in the output images PB41 to PB43 illustrated in FIG. 11 similarly to the first and second examples, but it is possible to adopt a configuration in which the indicators IN41 to IN43 are not displayed. In addition, if only this example is used, it is possible to adopt a configuration in which the tracking reliability is not calculated.

### Fourth Example

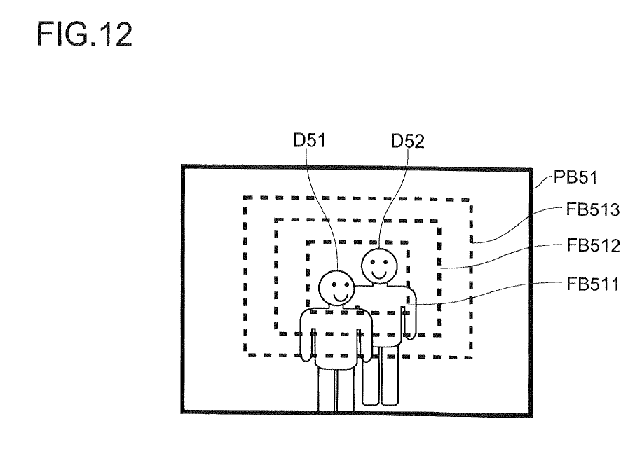

In fourth to tenth examples, the case where the object is a human face is exemplified for a specific description. Note that, in FIGS. 12 to 18 illustrating the fourth to tenth examples, the region of a detected face is not displayed in the output image, but it is possible to display the face region. For instance, a part of the display image processing unit 12b may generate a rectangular region enclosing the detected face based on the object information and may superimpose the rectangular region on the output image.

In addition, the fourth to sixth examples describe the view angle candidate frames that are generated in the case where a plurality of objects are detected from the input image.

In the fourth example, view angle candidate frames FB511 to FB513 are generated based on a plurality of objects D51 and D52 as illustrated in FIG. 12. For instance, view angle candidate frames FB511 to FB513 are generated based on barycentric positions of the plurality of objects D51 and D52. Specifically, for example, the view angle candidate frames FB511 to FB513 are generated so that barycentric positions of the plurality of objects D51 and D52 substantially match center positions of the view angle candidate frames FB511 to FB513.

With this configuration, when the plurality of objects D51 and D52 are detected from the input image, it is possible to generate the view angle candidate frames FB511 to FB513 indicating the angle of views including the objects D51 and D52.

Note that, it is possible to adopt a configuration in which the user operates the operating unit 17 (e.g., a zoom key, a cursor key, and an enter button) as described above, and changes the temporarily determined view angle candidate frame in turn so as to determine one of the view angle candidate frames. In this case, it is possible to adopt a configuration in which the temporarily determined view angle candidate frame is changed in the order of sizes (candidate values of the zoom magnification) of the view angle candidate frames.

Specifically, for example, it is possible to adopt a configuration in which the temporarily determined view angle candidate frame is changed in the order of FB511, FB512, FB513, FB511, and so on (or in the opposite order) in FIG. 12. In addition, the user may specify any position via the operating unit 17 (e.g., a touch panel), so that the view angle candidate frame that is closest to the position is determined or temporarily determined.

In addition, FIG. 12 exemplifies the case of generating view angle candidate frames in which all the detected obj ects are included, but it is possible to generate the view angle candidate frames including a part the detected objects. For instance, it is possible to generate the view angle candidate frames including only the object close to the center of the input image.

In addition, as described above, sizes of the view angle candidate frames FB511. to FB513 to be generated may be set to sizes corresponding to candidate values determined from the currently set zoom magnification and the upper limit value of the zoom magnification.

In addition, similarly to the second example, it is possible to set the number of the generated view angle candidate frames FB511 to FB513 based on one or both of detection accuracies of the objects D51 and D52 (e.g., similarity between an image feature for recognizing a face and the image indicating the object). Specifically, it is possible to decrease the number of the view angle candidate frames FB511 to FB513 to be generated as the detection accuracy becomes lower. In addition, similarly to the first example, it is possible to increase the sizes of the view angle candidate frames FB511 to FB513 as the detection accuracy becomes lower. In addition, as described above, it is possible to decrease the number of the view angle candidate frames FB511 to FB513 to be generated as the currently set zoom magnification becomes closer to the upper limit value of the zoom magnification.

### Fifth Example

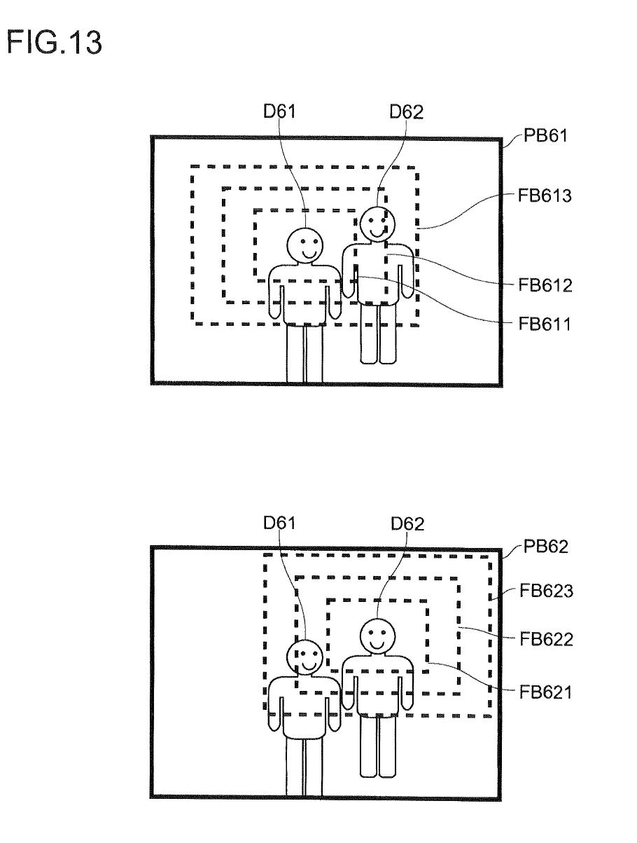

In a fifth example, as illustrated in the upper part of FIG. 13 as an output image PB61 and in the lower part of FIG. 13 as an output image PB62, view angle candidate frames FB611 to FB613 and FB621 to FB623 are generated based on each of a plurality of objects D61 and D62.

The view angle candidate frames FB611 to FB613 are generated based on the object D61, and the view angle candidate frames FB621 to FB623 are generated based on the object D62. For instance, the view angle candidate frames FB611 to FB613 are generated so that the center positions thereof are substantially the same as the center position of the object D61. In addition, for example, the view angle candidate frames FB621 to FB623 are generated so that the center positions thereof are substantially the same as the center position of the object D62.

With this configuration, when a plurality of objects D61 and D62 are detected, it is possible to generate the view angle candidate frames FB611 to FB613 indicating the angle of views including the object D61 and the view angle candidate frames FB621 to FB623 indicating the angle of views including the object D62.

Note that, as described above in the fourth example, it is possible to adopt a configuration in which the user changes the temporarily determined view angle candidate frame in turn so as to determine one of the view angle candidate frames. Further in this case, it is possible to adopt a configuration in which the temporarily determined view angle candidate frame is changed in the order of sizes (candidate values of the zoom magnification) of the view angle candidate frames.

In addition, in this example, it is possible to designate the object for which the view angle candidate frames are generated preferentially. To generate the view angle candidate frame preferentially means, for example, to generate only the view angle candidate frames based on the designated object or to generate the view angle candidate frames sequentially from those based on the designated object, when the user changes the temporarily determined view angle candidate frame in turn.

Specifically, for example, in FIG. 13, if the view angle candidate frames FB611 to FB613 based on the object D61 are generated preferentially, it is possible to adopt a configuration in which the temporarily determined view angle candidate frame is changed in the order of FB611, FB612, FB613, FB611, and so on (or in the opposite order). In addition, it is possible to adopt a configuration in which the temporarily determined view angle candidate frame is changed in the order of FB611, FB612, FB613, FB621, FB622, FB623, FB611, and so on, or in the order of B613, FB612, FB611, FB623, FB622, FB621, FB613, and so on.

In addition, the method of designating the object for which the view angle candidate frames are generated preferentially may be, for example, a manual method in which the user designate the object via the operating unit 17. In addition, for example, the method may be an automatic method in which the object recognized as an object that is close to the center of the input image or the object the user has registered in advance (the object having a high priority when a plurality of objects are registered and prioritized) or a large object in the input image is designated.

With this configuration, the view angle candidate frames intended (or probably intended) by the user are generated preferentially. Therefore, the user can easily determine the view angle candidate frame. For instance, it is possible to reduce the number of times the user changes the temporarily determined view angle candidate frame.

In addition, as described above, it is possible to set sizes of the view angle candidate frames FB611 to FB613 and FB621 to FB623 to be generated to sizes corresponding to candidate values determined from the currently set zoom magnification and the upper limit value of the zoom magnification.

In addition, similarly to the second example, it is possible to set the number of the generated view angle candidate frames FB611 to FB613 and the number of the generated view angle candidate frames FB621 to FB623 based on detection accuracies of the objects D61 and D62, respectively. Specifically, it is possible to set the number of the generated view angle candidate frames FB611 to FB613 and the number of the generated view angle candidate frames FB621 to FB623 as the detection accuracies become lower, respectively. In addition, similarly to the first example, it is possible to increase the sizes of the view angle candidate frames F611 to FB613 and FB621 to FB623 as the detection accuracies become lower. In addition, as described above, it is possible to decrease the number of the generated view angle candidate frames F611 to FB613 and the number of the generated view angle candidate frames FB621 to FB623 as the currently set zoom magnification becomes closer to the upper limit value of the zoom magnification. In addition, it is possible to set the number of the view angle candidate frames to a larger value for an object for which the view angle candidate frames are generated preferentially.

In addition, it is possible to determine whether to generate the view angle candidate frames FB511 to FB513 of the fourth example or to generate the view angle candidate frames FB611 to FB613 and FB621 to FB623 of this example based on a relationship (e.g., positional relationship) of the detected objects. Specifically, if the relationship of the objects is close (e.g., the positions are close to each other), the view angle candidate frames FB511 to FB513 of the fourth example may be generated. In contrast, if the relationship of the objects is not close (e.g., the positions are distant from each other), the view angle candidate frames FB611 to FB613 and FB621 to FB623 of this example may be generated.

### Sixth Example

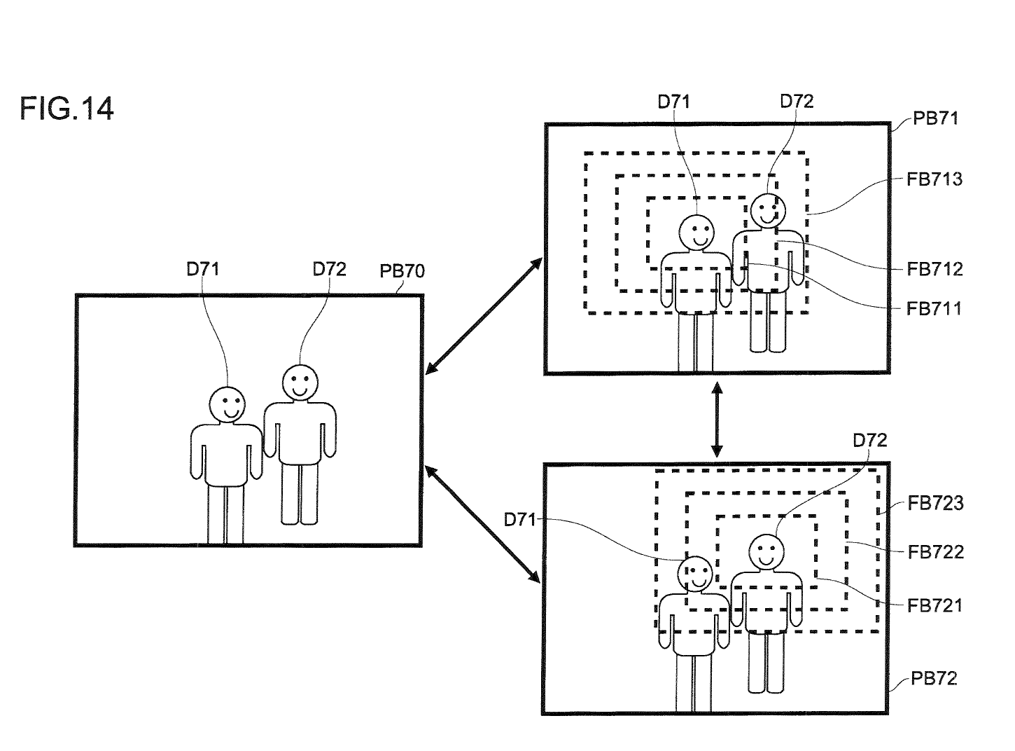

A sixth example is directed to an operating method when the temporarily determined view angle candidate frame is changed as described above in the fourth and fifth examples, as illustrated in FIG. 14. In this example, the operating unit 17 is constituted of a touch panel or the like so as to be capable of designating any position in the output image, and the user changes the temporarily determined view angle candidate frame in accordance with the number of times of designating (touching) a position of the object in the output image via the operating unit 17.

Specifically, for example, when the user designates a position of an object D71 in an output image PB70 for which the view angle candidate frames are not generated, view angle candidate frames FB711 to FB713 are generated based on the object D71 as in an output image PB71. In this case, the view angle candidate frame FB711 is first temporarily selected. After that, every time a position of the object D71 is designated via the operating unit 17, the temporarily determined view angle candidate frame is changed in the order of FB712, FB713, and FB711. Alternatively, the view angle candidate frame FB713 is first temporarily selected. After that, every time a position of the object D71 is designated via the operating unit 17, the temporarily determined view angle candidate frame is changed in the order of FB712, FB711, and FB713.

Further, for example, when the user designates a position of an object D72 in the output image PB70 for which the view angle candidate frames are not generated, view angle candidate frames FB721 to FB723 are generated based on the object D72 as in an output image PB72. In this case, the view angle candidate frame FB721 is first temporarily selected. After that, every time a position of the object D72 is designated via the operating unit 17, the temporarily determined view angle candidate frame is changed in the order of FB722, FB723, and FB721. Alternatively, the view angle candidate frame FB723 is first temporarily selected. After that, every time a position of the object D72 is designated via the operating unit 17, the temporarily determined view angle candidate frame is changed in the order of FB722, FB721, and FB723.

In addition, for example, if the user designates a position other than the objects D71 and D72 in the output images P871 and PB72, the display returns to the output image PB70 for which the view angle candidate frames are not generated. In addition, when the user designates a position of the object D72 in the output image PB71, the view angle candidate frames FB721 to FB723 are generated based on the object 72, and any one of the view angle candidate frames FB721 to FB723 (e.g., FB721) is temporarily determined. On the contrary, if the user designates a position of the object D71 in the output image PB72, the view angle candidate frames FB711 to FB713 are generated based on the object 71, and any one of the view angle candidate frames FB711 to FB713 (e.g., FB711) is temporarily determined.

With this configuration, it is possible to generate and determine a desired view angle candidate frame only by the user designating a position of the desired object in the output image. In addition, it is possible to stop the generation of the view angle candidate frames (not to display the view angle candidate frames on the display unit) only by designating a position other than the object in the output image. Therefore, it is possible to make the user's operation for determining one of the view angle candidate frames be intuitive and easy.

Note that, the case where the view angle candidate frames FB711 to FB713 and FB721 to FB723 are generated based on any one of the plurality of objects D71 and D72 as in the fifth example has been described, but it is possible to generate the view angle candidate frames based on the plurality of objects D71 and D72 as in the fourth example.

In this case, for example, it is possible to adopt a configuration in which the user designates positions of the objects D71 and D72 substantially at the same time via the operating unit 17, or the user designates positions on the periphery of an area including the objects D71 and D72 continuously (e.g., touches the touch panel so as to draw a circle or a rectangle enclosing the objects D71 and D72), so that the view angle candidate frames are generated based on the plurality of objects D71 and D72. Further, it is possible to adopt a configuration in which the user designates, for example, barycentric positions of the plurality of objects D71 and D72 or a position inside the rectangular area or the like enclosing the objects D71 and D72, so that the temporarily determined view angle candidate frame is changed. In addition, it is possible to adopt a configuration in which the user designates a point sufficiently distant from barycentric positions of the plurality of objects D71 and D72 or a position outside the rectangular area or the like enclosing the objects D71 and D72, so as to return to the output image PB70 for which the view angle candidate frames are not generated.

### Seventh Example

The seventh to tenth examples describe view angle candidate frames that are generated sequentially. In the flowchart illustrated in FIG. 6, if the user does not determine one of the view angle candidate frames (NO in STEP 4), the view angle candidate frames are generated repeatedly (STEP 2b), which is described below.

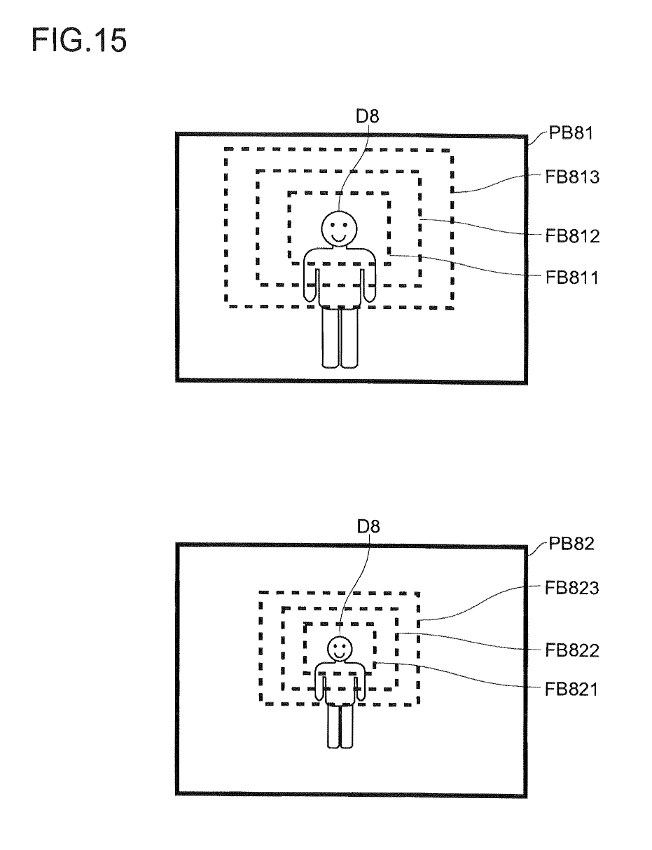

In the seventh example, as illustrated in the upper part of FIG. 15 as an output image PB81 and in the lower part of FIG. 15 as an output image PB82, view angle candidate frames FB811 to FB813 and FB821 to FB823 corresponding to a variation in size of an object D8 in the input image are generated. For instance, a size variation amount of the view angle candidate frames FB811 to FB813 and FB821 to FB823 is set to be substantially the same as a size variation amount of the object D8.

Specifically, for example, if a size of the object D8 in the input image illustrated in the lower part of FIG. 15 is 0.7 times a size of the object D8 in the input image illustrated in the upper part of FIG. 15, sizes of the view angle candidate frames FB821 to FB823 in the output image PB82 illustrated in the lower part of FIG. 15 are set respectively to 0.7 times sizes of the view angle candidate frames FB811 to FB813 in the output image PB81 illustrated in the upper part of FIG. 15.

With this configuration, a ratio of a size of the view angle candidate frame to a size of the object D8 can be maintained. Therefore, it is possible to suppress a variation in size of the object D8 in the input image after the zoom operation in accordance with a size of the object D8 in the input image before the zoom operation.

Note that, it is possible to generate the view angle candidate frames so that a size of the object in the minimum view angle candidate frames FB811 and FB821 becomes constant, so as to use the view angle candidate frames as a reference for determining other view angle candidate frames. With this configuration, view angle candidate frames can easily be generated.

In addition, in this example, sizes of the generated view angle candidate frames vary in accordance with a variation in size of the object D8 in the input image. Therefore, the view angle candidate frames may be fluctuated in the output image, which may adversely affect the user's operation. Therefore, it is possible to reduce the number of view angle candidate frames to be generated (e.g., to one), when the view angle candidate frames are generated by the method of this example. With this configuration, it is possible to suppress the fluctuation of the view angle candidate frames in the output image.

In addition, it is possible to adopt a configuration in which sizes of the view angle candidate frames are reset if a size variation amount of the object D8 in the input image is equal to or larger than a predetermined value. With this configuration too, it is possible to suppress the fluctuation of the view angle candidate frames in the output image.

In addition, it is possible to adopt a configuration in which the view angle candidate frames of fixed sizes are generated regardless of a variation in size of the object D8 in the input image by the user's setting in advance or the like. With this configuration, it is possible to suppress a variation in size of the background in the input image after the zoom operation (e.g., a region excluding the object D8 in the input image or a region excluding the object D8 and its peripheral region) in accordance with a size of the object D8 in the input image before the zoom operation.

### Eighth Example

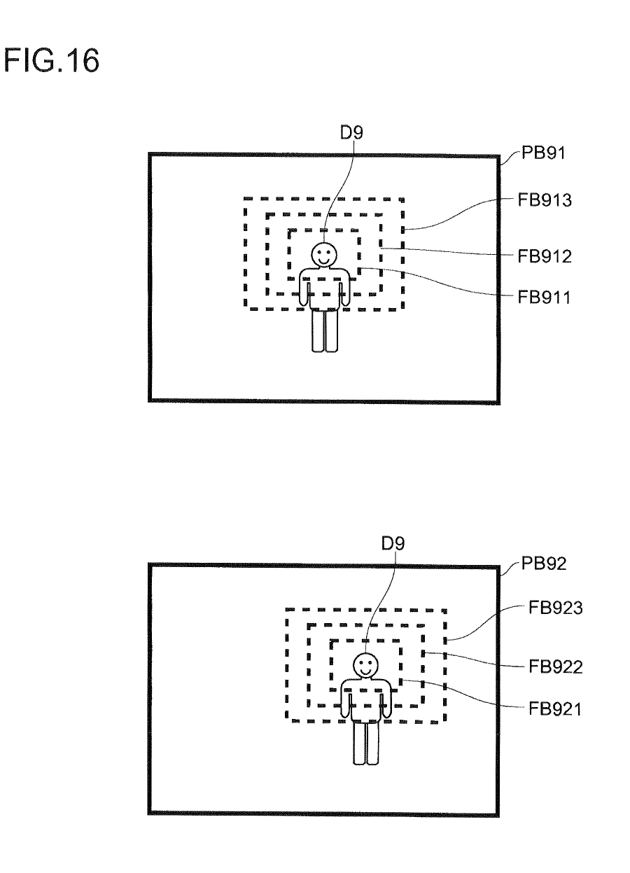

In the eighth example, as illustrated in the upper part of FIG. 16 as an output image PB91 and in the lower part of FIG. 16 as an output image PB92, view angle candidate frames FB911 to FB913 and FB921 to FB923 corresponding to a variation in position of the object D9 in the input image are generated. For instance, a positional variation amount of the view angle candidate frames FB911 to FB913 and FB921 to FB923 is set to be substantially the same as a positional variation amount of the object D9 (which may also be regarded as a moving velocity of the object).

With this configuration, a position of the object D9 in the view angle candidate frames can be maintained. Therefore, it is possible to suppress a variation in position of the object D9 in the input image after the zoom operation in accordance with a position of the object D9 in the input image before the zoom operation.

Note that, in this example, positions of the generated view angle candidate frames vary in accordance with a variation in position of the object D9 in the input image. Therefore, the view angle candidate frames may be fluctuated in the output image, which may adversely affect the user's operation. Therefore, it is possible to reduce the number of view angle candidate frames to be generated (e.g., to one), when the view angle candidate frames are generated by the method of this example. With this configuration, it is possible to suppress the fluctuation of the view angle candidate frames in the output image.

In addition, it is possible to adopt a configuration in which positions of the view angle candidate frames are reset if at least apart of the object D9 moves out of the minimum view angle candidate frames FB911 and FB921, or if a positional variation amount of the object D9 in the input image is equal to or larger than a predetermined value (e.g., the center position is deviated by a predetermined number of pixels or more). With this configuration too, it is possible to suppress the fluctuation of the view angle candidate frames in the output image.

In addition, as described above in the fourth example, it is possible to determine one of the view angle candidate frames when the user changes the temporarily determined view angle candidate frame in turn. Further in this case, it is possible to adopt a configuration in which the temporarily determined view angle candidate frame is changed in the order of sizes (candidate values of the zoom magnification) of the view angle candidate frames. Specifically, for example, the temporarily determined view angle candidate frame may be changed in the order of FB911, FB912, FB923, FB921, and so on (here, it is supposed that the object moves during the change from FB912 to FB923 to change from the state of the output image PB91 to the state of the output image PB92). In addition, for example, the temporarily determined view angle candidate frame may be changed in the order of FB913, FB912, FB921, FB923, and so on (here, it is supposed that the object moves during the change from FB912 to FB921 to change from the state of the output image PB91 to the state of the output image PB92).

If the temporarily determined view angle candidate frame is changed in this way, the order of the temporarily determined view angle candidate frame can be succeeded even if the object moves to change the state of the output image. Therefore, the user can easily determine one of the view angle candidate frames.

In addition, it is possible not to succeed (but to reset) the order of the temporarily determined view angle candidate frame before and after the change in state of the output image (movement of the object) if a positional variation amount of the object D9 is equal to or larger than a predetermined value. Specifically, for example, the temporarily determined view angle candidate frame may be changed in the order of FB911, FB921, FB922, and so on or in the order of FB911, FB923, FB921, and so on (here, it is supposed that the object moves during the change from FB911 to FB921 or FB923 to change the state of the output image PB91 to the state of the output image PB92). In addition, for example, the temporarily determined view angle candidate frame may be changed in the order of FB913, FB923, FB922, and so on or in the order of FB913, FB921, FB923, and so on (here, it is supposed that the object moves during the change from FB913 to FB923 or FB921 to change the state of the output image PB91 to the state of the output image PB92).

With this configuration, it is possible to reset the order of the temporarily determined view angle candidate frame when the object moves significantly so that the state of the output image is changed significantly. Therefore, the user can easily determine one of the view angle candidate frames. Further, if the largest view angle candidate frame is temporarily determined after movement of the object, the object after movement can be accurately contained in the temporarily determined view angle candidate frame.

### Ninth Example

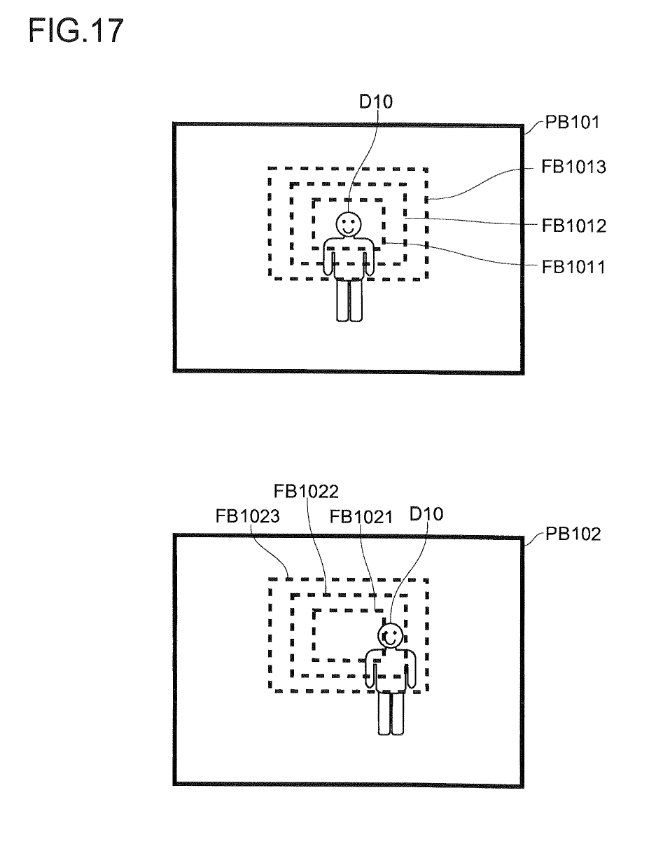

In a ninth example, as illustrated in the upper part of FIG. 17 as an output image PB101 and in the lower part of FIG. 17 as an output image PB102, view angle candidate frames FB1011 to FB1013 and FB1021 to FB1023 corresponding to a variation in position of a background (e.g., region excluding an object D10 in the input image or a region excluding the object D10 and its peripheral region) in the input image are generated. For instance, a positional variation amount of the view angle candidate frames FB1011 to FB1013 and FB1021 to FB1023 is set to be substantially the same as a positional variation amount of the background. Note that, in the output images PB101 and PB102 illustrated in FIG. 17, it is supposed that the object D10 moves while the background does not move.

The positional variation amount of the background can be determined by, for example, comparing image characteristics (e.g., contrast and high frequency components) in the region excluding the object D10 and its peripheral region in the sequentially generated input images.

With this configuration, a position of the background in the view angle candidate frame can be maintained. Therefore, it is possible to suppress a variation in position of the background in the input image after the zoom operation in accordance with a position of the background in the input image before the zoom operation.

Note that, in this example, positions of the generated view angle candidate frames vary in accordance with a variation in position of the background in the input image. Therefore, the view angle candidate frames may be fluctuated in the output image, which may adversely affect the user's operation. Therefore, it is possible to reduce the number of view angle candidate frames to be generated (e.g., to one), when the view angle candidate frames are generated by the method of this example. With this configuration, it is possible to suppress the fluctuation of the view angle candidate frames in the output image.

In addition, if a positional variation amount of the background in the input image is equal to or larger than a predetermined value (e.g., a value large enough to suppose that the user has panned the imaging device 1), it is possible not to generate the view angle candidate frames by the method of this example. In addition, for example, in this case, it is possible to set positions of the view angle candidate frames in the output image constant (so that the view angle candidate frames do not move).

### Tenth Example

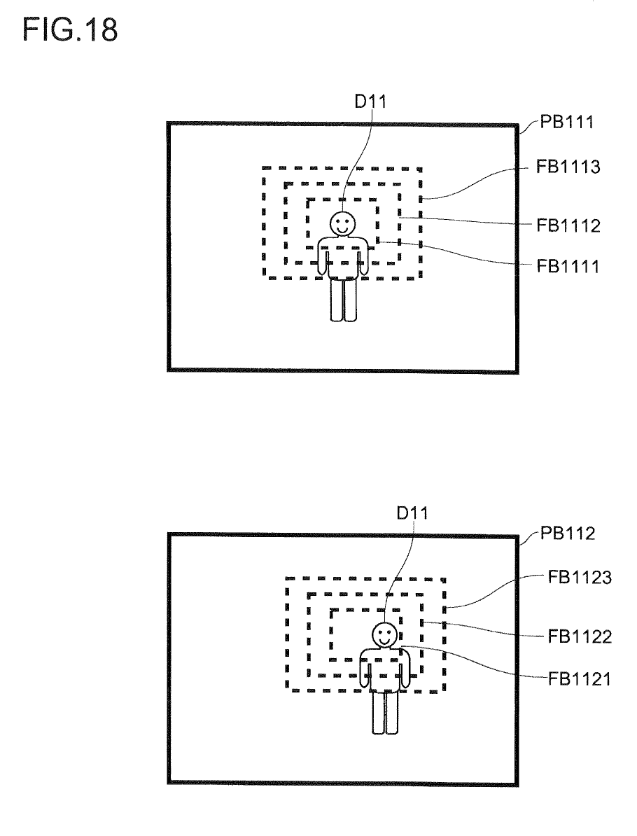

This example generates view angle candidate frames FB1111 to FB1113 and FB1121 to FB1123 corresponding to a position variation of an object D11 and the background in the input image (e.g., the region except the object D11 in the input image or the region except the object D11 and its peripheral region) as illustrated in the upper part of FIG. 18 as an output image PB111 and in the lower part of FIG. 18 as an output image PB112, respectively. For instance, the view angle candidate frames FB1111 to FB1113 and FB1121 to FB1123 are generated by the method for a combination of the generation method for a view angle candidate frame in the above-mentioned eighth example and the generation method therefor in the above-mentioned ninth example.

Specifically, a coordinate position of the view angle candidate frames generated by the method of the eighth example in the output image (e.g., FB921 to FB923 in the output image PB92 illustrated in the lower part of FIG. 16) is denoted by (xₜ, yₜ). A coordinate position of the view angle candidate frames generated by the method of the ninth example in the output image (e.g., FB1021 to FB1023 in the output image PB102 illustrated in the lower part of FIG. 17) is denoted by (x_{b}, y_{b}). Then, a coordinate position (X, Y) of the view angle candidate frames generated by the method of this example in the output image (e.g., FB1121 to FB1123 in the output image PB112 illustrated in the lower part of FIG. 18) is determined by linear interpolation between (xₜ, yₜ) and (x_{b}, y_{b}) as shown in Expression (3) below. Note that, it is supposed that sizes of the view angle candidate frames generated by the individual methods of the eighth example and the ninth example are substantially the same.

X=xₜ×rₜ+x_{b}×r_{b}

Y=yₜ×rₜ+y_{b}×r_{b} (3)

In Expression (3), rₜ denotes a weight of the view angle candidate frame generated by the method of the eighth example. As the value becomes larger, the position becomes closer to the view angle candidate frame corresponding to the position variation amount of the object D11 in the input image. In addition, r_{b} in Expression (3) denotes a weight of the view angle candidate frame generated by the method of the ninth example. As the value becomes larger, the position becomes closer to the view angle candidate frame corresponding to the variation amount of the background position in the input image. However, it is supposed that each of rₜ and r_{b} has a value within the range from 0 to 1, and a sum of rₜ and r_{b} is 1.

With this configuration, it is possible to maintain the positions of the object D11 and the background in the view angle candidate frame by a degree that the user wants. Therefore, it is possible to set the positions of the object D11 and the background in the input image after the zoom operation to positions that the user wants.

Note that, values of rₜ and r_{b} may be designated by the user or may be values that vary in accordance with a state of the input image or the like. If the values of rₜ and r_{b} vary, for example, the values may vary based on a size, a position or the like of the object D11 in the input image. Specifically, for example, as a size of the object D11 in the input image becomes larger, or as a position thereof becomes closer to the center, it is more conceivable that the object D11 is a main subject, and hence the value of rₜ may be increased.

With this configuration, it is possible to control the positions of the object D11 and the background in the view angle candidate frame adaptively in accordance with a situation of the input image. Therefore, it is possible to set accurately the positions of the object D11 and the background in the input image after the zoom operation to positions that the user wants.

In addition, the view angle candidate frame determined by Expression (3) may be set as any one of (e.g., the minimum one of) view angle candidate frames, so as to determine other view angle candidate frames with reference to the view angle candidate frame. With this configuration, the view angle candidate frames can easily be generated.

### Example 3

Example 3 of the display image processing unit 12 is described.

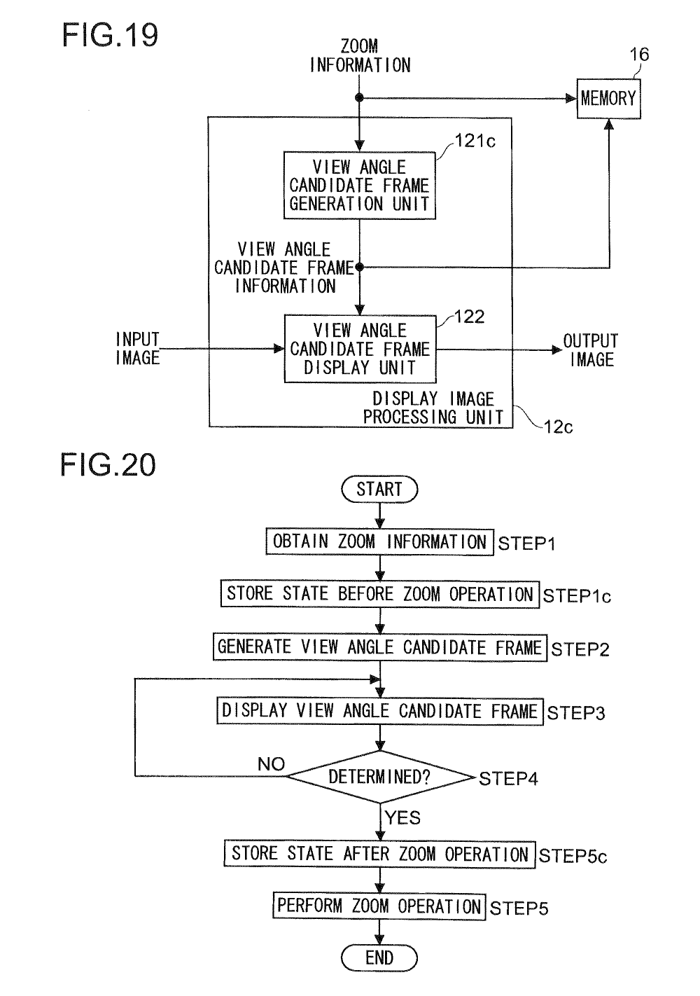

FIG. 19 is a block diagram illustrating a configuration of Example 3 of the display image processing unit provided to the imaging device according to the embodiment of the present invention, which corresponds to FIG. 2 illustrating Example 1. Note that, in FIG. 19, parts similar to those in FIG. 2 illustrating Example 1 are denoted by similar names and symbols so that detailed descriptions thereof are omitted.

As illustrated in FIG. 19, a display image processing unit 12c of this example includes a view angle candidate frame generation unit 121c which generates the view angle candidate frames based on the zoom information and outputs the view angle candidate frames as the view angle candidate frame information, and the view angle candidate frame display unit 122. This example is different from Example 1 in that the view angle candidate frame generation unit 121c outputs the view angle candidate frame information to the memory 16, and the zoom information is supplied to the memory 16 so that those pieces of information are stored.

In addition, an operation of the display image processing unit 12c of this example is described with reference to FIG. 20. FIG. 20 is a flowchart illustrating an operational example of the display image processing unit of Example 3, which corresponds to FIG. 3 illustrating Example 1. Note that, in FIG. 20, parts similar to those in FIG. 3 illustrating Example 1 are denoted by similar names and symbols so that detailed descriptions thereof are omitted.

Similarly to Example 1, in the preview operation before recording an image or in recording operation of a moving image, the input image output from the taken image processing unit 6 is supplied to the display image processing unit 12c via the bus line 20. In this case, if an instruction for the zoom in operation is not supplied to the imaging device 1 from the user via the operating unit 17, the display image processing unit 12c outputs the input image as it is to be an output image.

On the other hand, if an instruction from the user to perform the zoom in operation is supplied to the imaging device 1, the display image processing unit 12c performs the display operation of the view angle candidate frames illustrated in FIG. 20. When the display operation of the view angle candidate frames is started, the view angle candidate frame generation unit 121c first obtains the zoom information (STEP 1). Further, in this example, the zoom information is supplied also to the memory 16 so that the zoom state before the zoom in operation is performed is stored (STEP 1c).

Then, similarly to Example 1, the view angle candidate frame generation unit 121c generates the view angle candidate frames based on the zoom information (STEP 2), and the view angle candidate frame display unit 122 generates the output image by superimposing the view angle candidate frames on the input image so that the display unit displays the output image (STEP 3). Further, the user determines one of the view angle candidate frames (YES in STEP 4), and the angle of view (zoom magnification) after the zoom in operation is determined.

In this example, the view angle candidate frame information indicating the view angle candidate frame determined by the user is supplied to the memory 16 so that the zoom state after the zoom in operation is stored (STEP 5c). Then, the zoom in operation is performed so as to obtain an image of the angle of view of the view angle candidate frame determined in STEP 4 (STEP 5), and the operation is finished.

It is supposed that the zoom states before and after the zoom in operation stored in the memory 16 can promptly be retrieved by a user's instruction. Specifically, for example, when the user performs such an operation as pressing a predetermined button of the operating unit 17, the zoom operation is performed so that the stored zoom state is realized.

With the configuration described above, similarly to Example 1, the user can check the angle of view after the zoom in operation before performing the zoom in operation. Therefore, it is easy to obtain an image of a desired angle of view so that zoom operability can be improved. In addition, it is possible to reduce the possibility of losing sight of the object during the zoom in operation.

Further, an executed zoom state is stored in this example so that the user can realize the stored zoom state promptly without readjusting the zoom state. Therefore, even if predetermined zoom in and zoom out operations are repeated frequently, the zoom operation can be performed promptly and easily.

Note that, the storage of zoom state according to this example may be performed only in recording operation of a moving image. Most cases where the zoom in and zoom out operations need be repeated promptly and easily are the cases of recording moving images. Therefore, even if this example is applied only to such cases, this example can be performed appropriately.

In addition, instead of storing only one by one of the zoom states before and after the zoom in operation (i.e., the telephoto side and the wide side), it is possible to store other zoom states. In this case, it is possible to adopt a configuration in which a thumbnail image can be displayed on the display unit so that a desired zoom state can easily be determined from the stored plurality of zoom states. The thumbnail image can be generated, for example, by storing the image that is taken actually by the zoom state and by reducing the image.

Note that, the view angle candidate frame generation unit 121c generates the view angle candidate frame based on only the zoom information similarly to Example 1, but it is possible to adopt a configuration in which the view angle candidate frame is generated based on also the object information similarly to Example 2. In addition, as the zoom operation performed in this example, not only the optical zoom but also the electronic zoom may be used. Further, both of the optical zoom and the electronic zoom may be used in combination.

In addition, similarly to Example 1 and Example 2, if this example is applied to the imaging device 1 using the optical zoom, the zoom operation is performed easily so that failure is suppressed. Therefore, driving quantity of the zoom lens or the like is reduced so that power consumption can be reduced.

### Other Application Examples

### Application to Zoom Out Operation

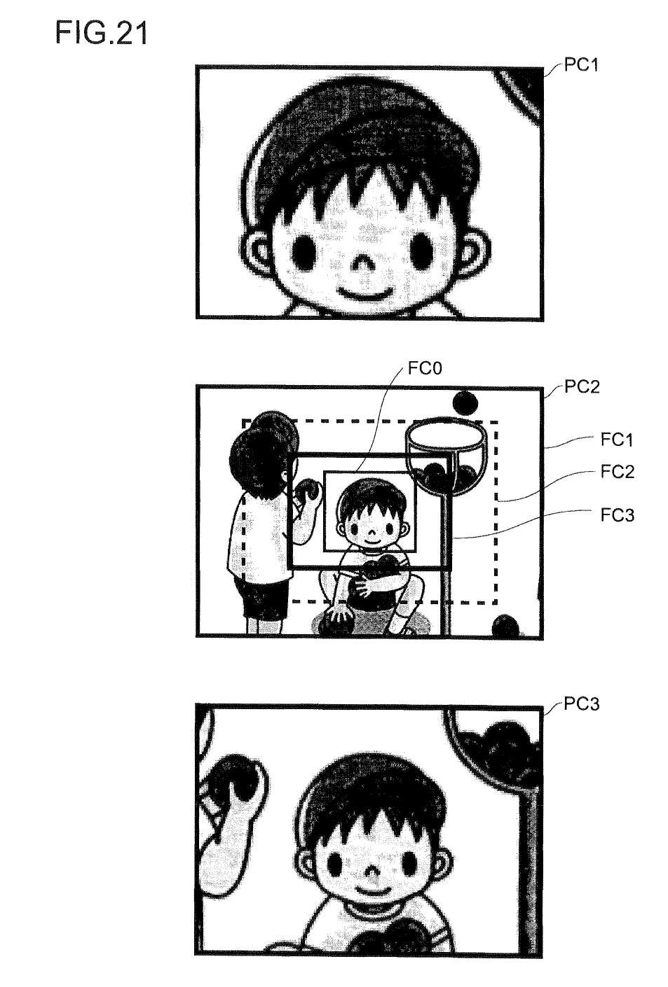

In the examples described above, the zoom in operation is mainly described. However, each of the examples can be applied to the zoom out operation, too. An example of the application to the zoom out operation is described with reference to the drawings. FIG. 21 is a diagram illustrating an example of a generation method for view angle candidate frames when the zoom out operation is performed, which corresponds to FIGS. 4 and 7 illustrating the case where the zoom in operation is performed. Note that, the case where the display image processing unit 12a of Example 1 is applied is exemplified for description, with reference to FIGS. 2 and 3 as appropriate.

In the case where an output image PC1 illustrated in the upper part of FIG. 21 is obtained, if an instruction to perform the zoom out operation is issued from the user to the imaging device 1, similarly to the case where the zoom in operation is performed, the zoom information is obtained (STEP 1), the view angle candidate frames are generated (STEP 2), and the view angle candidate frames are displayed (STEP 3). However, in the case of this example, as illustrated in the middle part of FIG. 21 as an output image PC2, the angle of view of the output image PC2 on which the view angle candidate frames FC1 to FC3 are displayed is larger than an angle of view FC0 of the output image PC1 before displaying the view angle candidate frames. Note that, in the output image PC2 in the middle part of FIG. 21, the angle of view FC0 of the output image PC1 may also be displayed similarly to the view angle candidate frames FC1 to FC3 (e.g., the rim of angle of view FC0 may be displayed with a solid line or a broken line).

If the taken image processing unit 6 clips a partial area of the image obtained by imaging so as to generate the input image (including the case of enlarging or reducing the clipped image), it is possible to generate the output image PC2 by enlarging the area of the image to be clipped for generating the input image. Note that, even in recording a moving image, the output image PC2 can be generated without variation in the angle of view of the image for recording by setting the input image for display and the image for recording different from each other. In addition, in the preview operation, it is possible to clip without considering the image for recording, or enlarge the angle of view of the input image using the optical zoom (enlarge the area to be clipped).

After that, the determination (STEP 4) and the zoom operation (STEP 5) are performed similarly to the case where the zoom in operation is performed. For instance, if the view angle candidate frame FC3 is determined in STEP 4, the zoom operation is performed in STEP 5 so that the image of the relevant angle of view is obtained. Thus, the output image PC3 illustrated in the lower part of FIG. 21 is obtained. In this way, the zoom out operation is performed.

[Application to Reproducing Operation]

The examples described above are mainly applied to the case of an imaging operation, but each example can also be applied to a reproducing operation. In the case of applying to the reproducing operation, for example, a wide-angle image is taken and recorded in the external memory 10 in advance, while the display image processing unit 12 clips a part of the image so as to generate the image for reproduction. In particular, the area of the image to be clipped (angle of view) is increased or decreased while appropriate enlargement or reduction is performed by the electronic zoom so as to generate the image for reproduction of a fixed size. Thus, the zoom in or zoom out operation is realized. Note that, when applied to the reproducing operation as in this example, it is possible to replace the input image of each of the above-mentioned processes with the image for reproduction so as to perform each process.

[View Angle Controlled Image Clipping Process]

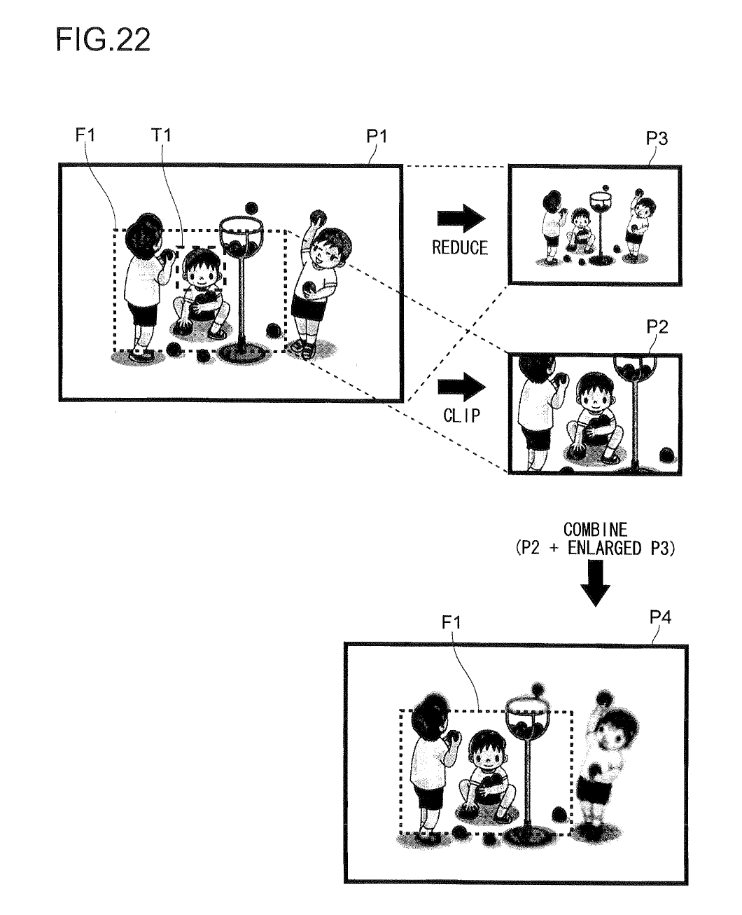

An example of the view angle controlled image clipping process, which enables the above-mentioned [Application to zoom out operation] and [Application to reproducing operation] to be suitably performed, is described with reference to FIG. 22. FIG. 22 is a diagram illustrating an example of the view angle controlled image clipping process. As illustrated in FIG. 22, the view angle controlled image clipping process of this example clips an image P2 of an angle of view F1 that is set based on a position and a size of a detected object T1 from an image P1 taken at wide angle (wide-angle image). By thus obtaining the clipped image P2, it is possible to reduce loads on the user in the imaging (such as directing the imaging device 1 to the object in a concentrated manner.

When the clipped image P2 is generated in the imaging operation, the taken image processing unit 6 detects the object T1 and performs the clipping process for obtaining the clipped image P2. In this case, for example, it is possible to record not only the clipped image P2 but also the wide-angle image P1 or a reduced image P3 that is obtained by reducing the wide-angle image P1 in the external memory 10 sequentially. If the reduced image P3 is recorded, it is possible to reduce a data amount necessary for recording. On the other hand, if the wide-angle image P1 is recorded, it is possible to suppress deterioration in image quality due to the reduction.

In the view angle controlled image clipping process of this example, the wide-angle image P1 is generated as a precondition of generating the clipped image P2. Therefore, it is possible to perform not only the zoom in operation in each example described above, but also the zoom out operation as described above in [Application to zoom out operation].

In the same manner, it is also possible to perform the reproduction operation as described above in [Application to reproducing operation]. For instance, it is supposed that the clipped image P2 is basically reproduced. In this case, in order to perform the zoom in operation in the reproduction operation, the clipped image P2 is sufficient for the purpose. On the other hand, in order to perform the zoom out operation, the image having an angle of view that is wider than the angle of view F1 of the clipped image P2 is necessary as described above. Here, it is needless to say that the wide-angle image P1 or the reduced image P3 that is recorded in the external memory 10 can be used as the wide-angle image, but a combination image P4 of the clipped image P2 and an enlarged image of the reduced image P3 can also be used. The combination image P4 means an image in which an angle of view outside the angle of view F1 of the clipped image P2 is supplemented with the enlarged image of the reduced image P3. Using the combination image P4, it is possible to reduce the data amount to be recorded in the external memory 10 and to obtain an image with an enlarged angle of view while maintaining image quality around the object T1.

Note that, it is also possible to adopt a configuration in which the clipped image P2 is generated in the reproduction operation. In this case, it is also possible to record the wide-angle image P1 or the reduced image P3 in the external memory 10, and the display image processing unit 12 may detect the object T1 or perform the clipping for generating the clipped image P2.

<Electronic Zoom>

It is possible to realize the electronic zoom in the above description by various electronic zoom operations as described below.

[Low Zoom]

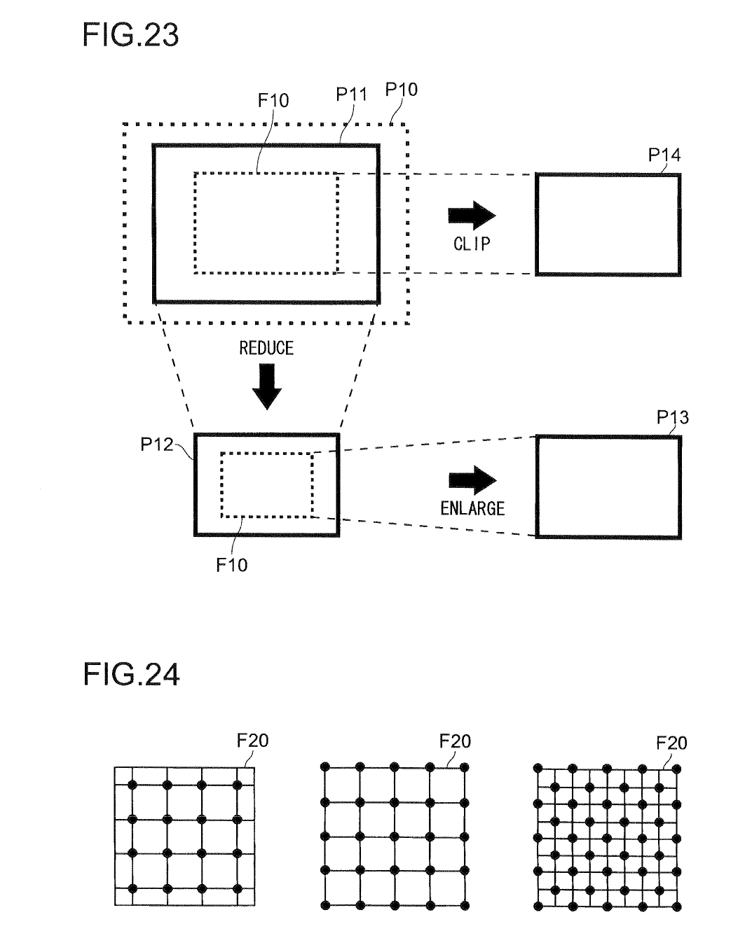

FIG. 23 is a diagram illustrating an example of a low zoom operation. As illustrated in FIG. 23, the low zoom is a process of generating a taken image P10 of high resolution (e.g., 8 megapixels) by imaging, clipping a part (e.g., 6 megapixels) or a whole of the taken image P10 so as to generate a clipped image P11, and reducing the clipped image P11 (e.g., to 2 megapixels, which is ⅓ times the clipped image P11, by a pixel addition process or a subsampling process) so as to obtain a target image P12.

It is supposed that the user issues an instruction to zoom in so that an image of an angle of view F10 that is a part of the target image P12 becomes necessary by the electronic zoom. In this case, a target image P13 obtained by enlarging the part to have the angle of view F10 in the target image P12 has image quality deteriorated from that of the clipped image P11 (taken image P10) because reduction and enlargement processes are involved in obtaining the target image P13.

However, if the image of the angle of view F10 is directly clipped from the clipped image P11 so as to generate target image P14, or if the directly clipped image of the angle of view F10 is enlarged or reduced so as to generate the target image, the target image P14 can be generated without the above-mentioned unnecessary reduction and enlargement processes. Therefore, it is possible to generate the target image P14 in which deterioration of image quality is suppressed.

Note that, in the case of the above-mentioned resolution, the target image P14 can be obtained without deterioration of the image quality of the clipped image P11 as long as the enlargement of the target image P12 is ×3 at most (as long as the angle of view F10 is ⅓ or larger of that of the target image P12).

[Super Resolution Processing]

FIG. 24 is a diagram illustrating an example of the super resolution processing. The left and middle parts of FIG. 24 illustrate parts of the image obtained by imaging, which have substantially the same angle of view F20 and are obtained by imaging at different timings (e.g., successive timings). Therefore, if these images are aligned and compared with each other as substantially the same angle of view F20, center positions of pixels (dots in FIG. 24) are shifted from each other in most cases.

In this example, images which have substantially the same angle of view F20 and have different center positions of pixels as in the case of the left and middle parts of FIG. 24 are combined appropriately. Thus, the high resolution image as illustrated in the right part of FIG. 24 is obtained in which information between pixels is interpolated.

Therefore, even if the user issues an instruction to perform the zoom in operation so that it becomes necessary to enlarge a part of the image, it is possible to obtain an image in which deterioration in image quality is suppressed by enlarging a part of the high resolution. image illustrated in the right part of FIG. 24.

Note that, the above-mentioned methods of the low zoom and the super resolution processing are merely examples, and it is possible to use other known methods.

<Example of Display Method of View Angle Candidate Frames>

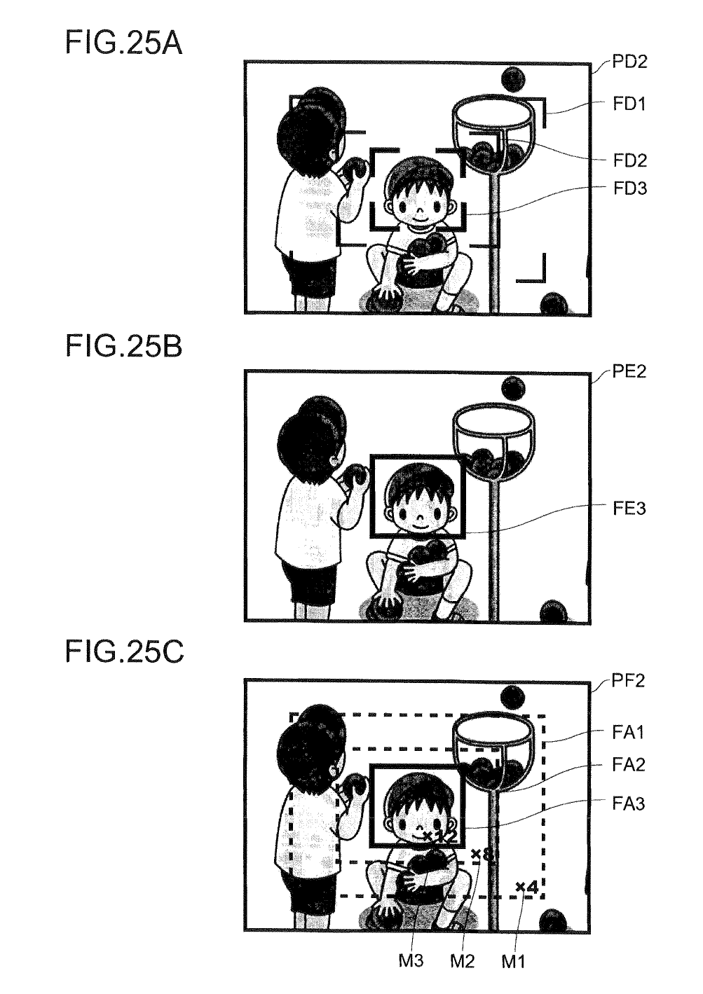

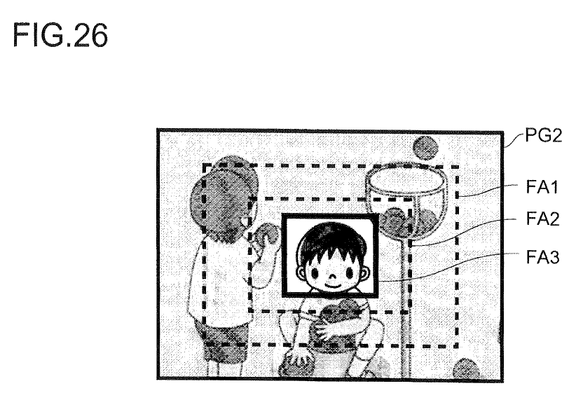

Various examples of the display method of the view angle candidate frames displayed on the output image are described with reference to FIGS. 25A to 25C and 26. FIGS. 25A to 25C and 26 are diagrams illustrating examples of the output image for describing various display examples of the view angle candidate frames. Note that, FIGS. 25A to 25C and 26 illustrate different display method examples, which correspond to the middle part of FIG. 4 as the output image PA2. In particular, it is supposed that the angle of view of the input image and the generated position of the view angle candidate frames (the zoom magnifications corresponding to each of the view angle candidate frames) as well as the number of the view angle candidate frames are the same between each of the middle parts of FIGS. 25A to 25C and 26 and FIG. 4 as output image PA2. Note that, the case of application to Example 1 as described, above is exemplified for description, but it is possible to apply to other examples in the same manner.

FIG. 25A illustrates an output image PD2 in which only four corners of the view angle candidate frames FD1 to FD3 are displayed. In addition, similarly to the middle part of FIG. 4 as the output image PA2, the temporarily determined view angle candidate frame FD3 is displayed with emphasis (e.g., with a thick line) while other view angle candidate frames FD1 and FD2 are displayed without emphasis (e.g., with a thin line).

With this method of display, displayed parts of the view angle candidate frames FD1 to FD3 can be reduced. Therefore, it is possible to reduce the possibility that the background image (input image) of the output image PD2 becomes hard to see due to the view angle candidate frames FD1 to FD3.

FIG. 25B illustrates an output image PE2 in which only a temporarily determined view angle candidate frame FE3 is displayed. Here, unlike the output image PA2 illustrated in the middle part of FIG. 4, the view angle candidate frames that are not temporarily determined (FE1 and FE2 if expressed in the same manner as the output image PA2 in the middle part of FIG. 4 and the output image PD2 in FIG. 25A) are not displayed (are not generated). However, each of the non-generated view angle candidate frames FE1 and FE2 is to be displayed (generated) if the user changes the temporarily determined view angle candidate frame. Therefore, the display method of this example can be interpreted to be a display method in which the view angle candidate frames FE1 and FE2, which are not temporarily determined, are not displayed.

With this method of display, the displayed part (i.e., only FE3) of the view angle candidate frames FE1 to FE3 can be reduced. Therefore, it is possible to reduce the possibility that the background image (input image) of the output image PE2 becomes hard to see due to the view angle candidate frame FE1.

FIG. 25C illustrates an output image PF2 which displays the view angle candidate frames FA1 to FA3 similarly to the output image PA2 illustrated in the middle part of FIG. 4. However, candidate values (zoom magnification values) M1 to M3 corresponding to the view angle candidate frames FA1 to FA3 are displayed at corners of the individual view angle candidate frames FA1 to FA3. Note that, when the above-mentioned secondary decision is performed, increased or decreased values of the zoom magnification M1 to M3 may be displayed along with deformation (fine adjustment) of the view angle candidate frames FA1 to FA3 or may not be displayed. In addition, the zoom magnification of the optical zoom and the zoom magnification of the electronic zoom may be displayed separately or may be displayed as a sum.

With this method of display, the user can recognize the zoom magnification when one of the view angle candidate frames FA1 to FA3 is determined. Therefore, the user can grasp in advance, for example, a shaking amount (probability of losing sight of the object) after the zoom operation or a state after the zoom operation such as deterioration in image quality.

FIG. 26 illustrates an output image PG2 which displays the view angle candidate frames FA1 to FA3 similarly to the output image PA2 illustrated in the middle part of FIG. 4. However, the outside of the temporarily determined view angle candidate frame FA3 is adjusted to be displayed in gray out on the display unit. Specifically, it is adjusted, for example, so that the image outside the temporarily determined view angle candidate frame FA3 becomes close to achromatic color and the luminance is increased (or decreased).

Note that, it is possible to adopt any adjustment method other than the gray out display as long as the inside and the outside of the temporarily determined view angle candidate frame FA3 are adjusted differently. For instance, the outside of the temporarily determined view angle candidate frame FA3 may be adjusted to be entirely filled with a uniform color, or the outside of the temporarily determined view angle candidate frame FA3 may be adjusted to be hatched. However, it is preferred to adopt the above-mentioned special adjustment method only for the outside of the temporarily determined view angle candidate frame FA3 so that the user can recognize the inside of the same.

With this method of display, the inside and the outside of the temporarily determined one of the view angle candidate frames FA1 to FA3 are displayed so as to be clearly distinguishable from each other. Therefore, the user can easily recognize the inside of the temporarily determined one of the view angle candidate frames FA1 to FA3 (i.e., the angle of view after the zoom operation).

Note that, it is possible to combine the methods illustrated in FIGS. 25A to 25C and 26. If all of them are combined, it is possible, for example, to display four corners of only the temporarily determined view angle candidate frame, and to display the zoom magnification at a corner of the view angle candidate frame, and further to gray out the outside of the temporarily determined view angle candidate frame.

### Other Variation Examples

In addition, the operations of the taken image processing unit 6 and the display image processing unit 12 in the imaging device 1 according to the embodiment of the present invention may be performed by a control device such as a microcomputer. Further, it is possible to describe a whole or a part of the functions realized by the control device as a program, and to make a program executing device (e.g., a computer) execute the program so that the whole or the part of the functions can be realized.

In addition, the present invention is not limited to the above-mentioned case, and the imaging device 1 and the taken image processing unit 6 illustrated in FIG. 1, and the display image processing units 12 and 12a to 12c illustrated in FIGS. 1, 2, 5, and 19 can be realized by hardware or a combination of hardware and software. In addition, if software is used for constituting the imaging device 1, the taken image processing unit 6, and the display image processing unit 12a to 12c, a block diagram of the parts realized by software represents a functional block diagram of the parts.

The embodiment of the present invention has been described above. However, the scope of the present invention is not limited to the embodiment, and various modifications may be made thereto without departing from the spirit thereof.

The present invention can be applied to an imaging device for obtaining a desired angle of view by controlling the zoom state. In particular, the present invention is preferably applied to an imaging device for which the user adjusts the zoom based on the image displayed on the display unit.
FIG. 1
2 IMAGE SENSOR
3 LENS UNIT
5 SOUND COLLECTING UNIT
6 TAKEN IMAGE PROCESSING UNIT
7 SOUND PROCESSING UNIT
8 COMPRESSION PROCESSING UNIT
9 DRIVER UNIT
10 EXTERNAL MEMORY
11 EXPANSION PROCESSING UNIT
12 DISPLAY IMAGE PROCESSING UNIT
13 IMAGE OUTPUT CIRCUIT UNIT
14 SOUND OUTPUT CIRCUIT UNIT
16 MEMORY
17 OPERATING UNIT
18 TG UNIT
(1) IMAGE SIGNAL
(2) SOUND SIGNAL
FIG. 2
12a DISPLAY IMAGE PROCESSING UNIT
121a VIEW ANGLE CANDIDATE FRAME GENERATION UNIT
122 VIEW ANGLE CANDIDATE FRAME DISPLAY UNIT
(1) ZOOM INFORMATION
(2) VIEW ANGLE CANDIDATE FRAME INFORMATION
(3) INPUT IMAGE
(4) OUTPUT IMAGE
FIG. 3
START
STEP 1 OBTAIN ZOOM INFORMATION
STEP 2 GENERATE VIEW ANGLE CANDIDATE FRAME
STEP 3 DISPLAY VIEW ANGLE CANDIDATE FRAME
STEP 4 DETERMINED?
STEP 5 PERFORM ZOOM OPERATION
END
FIG. 5
12b DISPLAY IMAGE PROCESSING UNIT
121b VIEW ANGLE CANDIDATE FRAME GENERATION UNIT
VIEW ANGLE CANDIDATE FRAME DISPLAY UNIT
(1) ZOOM INFORMATION
(2) OBJECT INFORMATION
(3) VIEW ANGLE CANDIDATE FRAME INFORMATION
(4) INPUT IMAGE
(5) OUTPUT IMAGE
FIG. 6
START
STEP 1 OBTAIN ZOOM INFORMATION
STEP 1b OBTAIN OBJECT INFORMATION
STEP 2b GENERATE VIEW ANGLE CANDIDATE FRAME
STEP 3 DISPLAY VIEW ANGLE CANDIDATE FRAME
STEP 4 DETERMINED?
STEP 5 PERFORM ZOOM OPERATION
END
FIG. 19
12c DISPLAY IMAGE PROCESSING UNIT
16 MEMORY
121c VIEW ANGLE CANDIDATE FRAME GENERATION UNIT
122 VIEW ANGLE CANDIDATE FRAME DISPLAY UNIT
(1) ZOOM INFORMATION
(2) VIEW ANGLE CANDIDATE FRAME INFORMATION
(3) INPUT IMAGE
(4) OUTPUT IMAGE
FIG. 20
START
STEP 1 OBTAIN ZOOM INFORMATION
STEP 1c STORE STATE BEFORE ZOOM OPERATION
STEP 2 GENERATE VIEW ANGLE CANDIDATE FRAME
STEP 3 DISPLAY VIEW ANGLE CANDIDATE FRAME
STEP 4 DETERMINED?
STEP 5c STORE STATE AFTER ZOOM OPERATION
STEP 5 PERFORM ZOOM OPERATION
END
FIG. 22
(1) REDUCE
(1) CLIP
(3) COMBINE (P2+ENLARGED P3)
FIG. 23
(1) CLIP
(2) REDUCE
(3) ENLARGE

What is claimed is:

1. An imaging device, comprising:
an input image generating unit which generates input images sequentially by imaging, which is capable of changing an angle of view of each of the input images; and
a display image processing unit which generates view angle candidate frames indicating angles of view of new input images to be generated when the angle of view is changed, and generates an output image by superimposing the view angle candidate frames on the input image.

2. An imaging device according to claim 1, further comprising an operating unit which determines one of the view angle candidate frames,
wherein the input image generating unit generates a new input image having an angle of view that is substantially the same as the angle of view indicated by the one of the view angle candidate frames determined via the operating unit.

3. An imaging device according to claim 1, further comprising an object detection unit which detects an object in the input image,
wherein the display image processing unit determines positions of the view angle candidate frames to be generated based on a position of the object in the input image detected by the object detection unit.

4. An imaging device according to claim 3, wherein at least one of a number and a size of the view angle candidate frames to be generated by the display image processing unit is determined based on at least one of accuracy of the detection of the object by the object detection unit and a size of the object.

5. An imaging device according to claim 3, wherein if the object detection unit detects a plurality of objects in the input image, the display image processing unit generates the view angle candidate frames that include at least one of the plurality of objects or generates the view angle candidate frames that include any one of the plurality of objects.

6. An imaging device according to claim 3, further comprising an operating unit which determines a view angle candidate frame and allowing any position in the output image to be designated, wherein:
any one of the view angle candidate frames generated by the display image processing unit is temporarily determined, the any one of the view angle candidate frames that is temporarily determined being changeable by an operation of the operating unit;
when a position in the output image of the object detected by the object detection unit is designated via the operating unit, the display image processing unit generates view angle candidate frames including the object; and
when a position of the object in the output image is designated via the operating unit repeatedly, the display image processing unit changes the any one of the view angle candidate frames that is temporarily determined among the view angle candidate frames including the object.

7. An imaging device according to claim 6, wherein when a position in the output image other than the object detected by the object detection unit is designated via the operating unit, the display image processing unit stops generation of the view angle candidate frames.

8. An imaging device according to 1, further comprising an operating unit which determines one of the view angle candidate frames, wherein:
any one of the view angle candidate frames generated by the display image processing unit is temporarily determined, the any one of the view angle candidate frames that is temporarily determined being changeable by an operation of the operating unit; and
the any one of the view angle candidate frames that is temporarily determined is changed in order of sizes of the view angle candidate frames generated by the display image processing unit.

9. An imaging device according to claim 1, further comprising an operating unit which determines one of the view angle candidate frames, wherein:
any one of the view angle candidate frames generated by the display image processing unit is temporarily determined, the any one of the view angle candidate frames that is temporarily determined being changeable by an operation of the operating unit; and
the display image processing unit generates the output image by superimposing the any one of the view angle candidate frames that is temporarily determined among the generated view angle candidate frames on the input image.

10. An imaging device according to claim 1, further comprising an operating unit which determines one of the view angle candidate frames, wherein:
any one of the view angle candidate frames generated by the display image processing unit is temporarily determined, the any one of the view angle candidate frames that is temporarily determined being changeable by an operation of the operating unit; and
the display image processing unit generates an output image in which an adjustment method is different between inside and outside of the any one of the view angle candidate frames that is temporarily determined.

11. An imaging device according to claim 1, wherein:
the input image generating unit is capable of changing the angle of view of the each of the sequentially generated input images by using at least one of optical zoom and electronic zoom; and
when the input image generating unit generates a new input image having an angle of view narrower than an angle of view of a currently generated input image, an image obtained by the imaging with the optical zoom is enlarged, and a part of the enlarged image is further enlarged by using the electronic zoom.

12. An imaging device according to claim 1, further comprising a storage unit which stores, when the input image generating unit that is capable of changing a zoom state in generation of the input images changes the zoom state, the zoom states before and after the change,
wherein the input image generating unit is capable of changing the zoom state by reading the zoom states stored in the storage unit.

13. An imaging device according to claim 1, wherein:
the input image generating unit generates the input images sequentially by clipping a partial area of images obtained sequentially by the imaging;
the input image generating unit enlarges the partial area to be clipped in the images obtained by the imaging to generate a new input image having an angle of view larger than an angle of view of a currently generated input image; and
the display image processing unit generates a new view angle candidate frame indicating the angle of view larger than the angle of view of the currently generated input image, and generates a new output image by superimposing the new view angle candidate frame on the new input image.
